(19) United States
(12) Patent Application Publication
(10) Pub. No.: US 2025/0184073 A1
(43) Pub. Date: Jun. 5, 2025

(54) MANAGING SELECTION OF TRANSMISSION RECEPTION POINTS

(71) Applicant: QUALCOMM INCORPORATED, San Diego, CA (US)

(72) Inventors: Fang Yuan, Beijing (CN); Yan Zhou, San Diego, CA (US); Tao Luo, San Diego, CA (US)

(21) Appl. No.: 18/841,998

(22) PCT Filed: Apr. 29, 2022
(86) PCT No.: PCT/CN2022/090794

§ 371 Date: Aug. 27, 2024

(51) Int. Cl. H04L 5/00; H04W 72/02; H04W 72/12; H04W 72/231

(52) U.S. Cl. CPC H04L 5/0051; H04W 72/02; H04W 72/12; H04W 72/231

(57) ABSTRACT

Methods, systems, and devices for wireless communication are described. A user equipment (UE) receive first control signaling that includes information indicative of a sounding reference signal (SRS) configuration. The SRS configuration indicating at least three SRS resource sets. each of the at least three SRS resource sets being associated with communication between the UE and a respective transmission reception point (TRP) during one of multi-TRP communications or single virtual TRP communication based on a set of multiple TRPs. The UE may receive second control signaling that triggers the UE to select one or more SRS resource sets from the at least three SRS resource sets for uplink communication. The UE may then communicate the uplink communication with one or more TRPs of the set of multiple TRPs based on the selected one or more SRS resource sets.

### CROSS REFERENCE

The present application is a 371 national stage filing of International PCT Application No. PCT/CN2022/090794 by Yuan et al. entitled “MANAGING SELECTION OF TRANSMISSION RECEPTION POINTS,” filed Apr. 29, 2022, which is assigned to the assignee hereof, and which is expressly incorporated by reference in its entirety herein.

### INTRODUCTION

The following relates to wireless communication, including managing wireless communication with one or multiple transmission reception points (TRPs).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communication at a UE is described. The method may include receiving first control signaling that includes information indicative of a sounding reference signal (SRS) configuration, the SRS configuration indicating at least three SRS resource sets, each of the at least three SRS resource sets being associated with communication between the UE and a respective transmission reception point (TRP) during one of multi-TRP communications or single virtual TRP communication based on a set of multiple TRPs, receiving second control signaling that triggers the UE to select one or more SRS resource sets from the at least three SRS resource sets for uplink communication, and communicating the uplink communication with one or more TRPs of the set of multiple TRPs based on the selected one or more SRS resource sets.

An apparatus for wireless communication is described. The apparatus may include a processor, and memory coupled with the processor, the processor configured to receive first control signaling that includes information indicative of a SRS configuration, the SRS configuration indicating at least three SRS resource sets, each of the at least three SRS resource sets being associated with communication between the UE and a respective TRP during one of multi-TRP communications or single virtual TRP communication based on a set of multiple TRPs, receive second control signaling that triggers the UE to select one or more SRS resource sets from the at least three SRS resource sets for uplink communication, and communicate the uplink communication with one or more TRPs of the set of multiple TRPs based on the selected one or more SRS resource sets.

Another apparatus for wireless communication at a UE is described. The apparatus may include means for receiving first control signaling that includes information indicative of a SRS configuration, the SRS configuration indicating at least three SRS resource sets, each of the at least three SRS resource sets being associated with communication between the UE and a respective TRP during one of multi-TRP communications or single virtual TRP communication based on a set of multiple TRPs, means for receiving second control signaling that triggers the UE to select one or more SRS resource sets from the at least three SRS resource sets for uplink communication, and means for communicating the uplink communication with one or more TRPs of the set of multiple TRPs based on the selected one or more SRS resource sets.

A non-transitory computer-readable medium storing code for wireless communication at a UE is described. The code may include instructions executable by a processor to receive first control signaling that includes information indicative of a SRS configuration, the SRS configuration indicating at least three SRS resource sets, each of the at least three SRS resource sets being associated with communication between the UE and a respective TRP during one of multi-TRP communications or single virtual TRP communication based on a set of multiple TRPs, receive second control signaling that triggers the UE to select one or more SRS resource sets from the at least three SRS resource sets for uplink communication, and communicate the uplink communication with one or more TRPs of the set of multiple TRPs based on the selected one or more SRS resource sets.

Some examples of the method, apparatuses, and non-transitory computer-readable medium described herein may further include operations, features, means, or instructions for determining a respective precoder for each of the one or more TRPs based on a respective SRS resource set of the at least three SRS resource sets associated with each of the one or more TRPs and where communicating the uplink communication may be further based on the determined respective precoder for each of the one or more TRPs.

Some examples of the method, apparatuses, and non-transitory computer-readable medium described herein may further include operations, features, means, or instructions for determining a respective quantity of SRS resources, a respective quantity of SRS ports, a respective quantity of demodulation reference signals, or any combination thereof associated with each of the one or more TRPs based on the received first control signaling and selecting the one or more SRS resource sets for the uplink communication based on the determined respective quantity of SRS resources, the determined respective quantity of SRS ports, the determined respective quantity of demodulation reference signals, or any combination thereof associated with each of the one or more TRPs.

Some examples of the method, apparatuses, and non-transitory computer-readable medium described herein may further include operations, features, means, or instructions for determining a respective beam or a respective transmission configuration indicator associated with each of the one or more TRPs and where communicating the uplink communication may be further based on using the determined respective beam or the respective transmission configuration indicator associated with each of the one or more TRPs.

In some examples of the method, apparatuses, and non-transitory computer-readable medium described herein, the received second control signaling schedules the multi-TRP communications or the single virtual TRP communication for the uplink communication with the one or more TRPs and the second control signaling includes downlink control information (DCI).

Some examples of the method, apparatuses, and non-transitory computer-readable medium described herein may further include operations, features, means, or instructions for determining that the received second control signaling schedules the multi-TRP communications based on an indication in the received second control signaling, selecting a first SRS resource set or a second SRS resource set, or both, based on that the received second control signaling schedules the multi-TRP communications, where communicating the uplink communication includes communicating the uplink communication with a first TRP or a second TRP, or both, using the selected first SRS resource set or the selected second SRS resource set, or both.

In some examples of the method, apparatuses, and non-transitory computer-readable medium described herein, a SRS resource indicator field or a precoding information and number of layers indicator field, or both, associated with the received second control signaling corresponds to the first TRP or the second TRP, or both associated with the set of multiple TRPs.

Some examples of the method, apparatuses, and non-transitory computer-readable medium described herein may further include operations, features, means, or instructions for determining that the received second control signaling schedules the single virtual TRP communication based on an indication in the received second control signaling, selecting a third SRS resource set based on that the received second control signaling schedules the single virtual TRP communication, where communicating the uplink communication includes communicating the uplink communication with a virtual TRP using the selected third SRS resource set, where the virtual TRP may be derived from the set of multiple TRPs.

In some examples of the method, apparatuses, and non-transitory computer-readable medium described herein, a SRS resource indicator field or a precoding information and number of layers indicator field, or both, associated with the received second control signaling corresponds to the third TRP associated with the set of multiple TRPs.

Some examples of the method, apparatuses, and non-transitory computer-readable medium described herein may further include operations, features, means, or instructions for receiving third control signaling activating the multi-TRP communications or the single virtual TRP communication for the uplink communication, the third control signaling including a medium access control-control element (MAC-CE) and where communicating the uplink communication with one or more TRPs may be further based on the received third control signaling.

Some examples of the method, apparatuses, and non-transitory computer-readable medium described herein may further include operations, features, means, or instructions for selecting at least one SRS resource set from the at least three SRS resource sets for the uplink communication based on the received third control signaling activating the single virtual TRP communication for the uplink communication, where communicating the uplink communication includes communicating the uplink communication with a virtual TRP using the selected at least one SRS resource set, where the virtual TRP may be derived from the set of multiple TRPs.

Some examples of the method, apparatuses, and non-transitory computer-readable medium described herein may further include operations, features, means, or instructions for ignoring the received second control signaling that triggers the UE to select the one or more SRS resource sets from the at least three SRS resource sets for uplink communication based on the received third control signaling.

Some examples of the method, apparatuses, and non-transitory computer-readable medium described herein may further include operations, features, means, or instructions for selecting at least two SRS resource set from the at least three SRS resource sets for the uplink communication based on the received third control signaling activating the multi-TRP communications for the uplink communication, where communicating the uplink communication includes communicating the uplink communication with a first TRP and a second transmission point using the selected at least two SRS resource sets.

In some examples of the method, apparatuses, and non-transitory computer-readable medium described herein, the SRS configuration corresponds to codebook-based wireless communication.

In some examples of the method, apparatuses, and non-transitory computer-readable medium described herein, the SRS configuration corresponds to non-codebook-based wireless communication.

A method for wireless communication at a network entity is described. The method may include outputting first control signaling that includes information indicative of a SRS configuration, the SRS configuration indicating at least three SRS resource sets, each of the at least three SRS resource sets being associated with communication between a UE and a respective TRP during one of multi-TRP communications or single virtual TRP communication based on a set of multiple TRPs and outputting second control signaling that triggers the UE to select one or more SRS resource sets from the at least three SRS resource sets for uplink communication with one or more TRPs of the set of multiple TRPs.

An apparatus for wireless communication is described. The apparatus may include a processor, and memory coupled with the processor, the processor configured to output first control signaling that includes information indicative of a SRS configuration, the SRS configuration indicating at least three SRS resource sets, each of the at least three SRS resource sets being associated with communication between a UE and a respective TRP during one of multi-TRP communications or single virtual TRP communication based on a set of multiple TRPs and output second control signaling that triggers the UE to select one or more SRS resource sets from the at least three SRS resource sets for uplink communication with one or more TRPs of the set of multiple TRPs.

Another apparatus for wireless communication at a network entity is described. The apparatus may include means for outputting first control signaling that includes information indicative of a SRS configuration, the SRS configuration indicating at least three SRS resource sets, each of the at least three SRS resource sets being associated with communication between a UE and a respective TRP during one of multi-TRP communications or single virtual TRP communication based on a set of multiple TRPs and means for outputting second control signaling that triggers the UE to select one or more SRS resource sets from the at least three SRS resource sets for uplink communication with one or more TRPs of the set of multiple TRPs.

A non-transitory computer-readable medium storing code for wireless communication at a network entity is described. The code may include instructions executable by a processor to output first control signaling that includes information indicative of a SRS configuration, the SRS configuration indicating at least three SRS resource sets, each of the at least three SRS resource sets being associated with communication between a UE and a respective TRP during one of multi-TRP communications or single virtual TRP communication based on a set of multiple TRPs and output second control signaling that triggers the UE to select one or more SRS resource sets from the at least three SRS resource sets for uplink communication with one or more TRPs of the set of multiple TRPs.

In some examples of the method, apparatuses, and non-transitory computer-readable medium described herein, a respective precoder for each of the one or more TRPs may be based on a respective SRS resource set of the at least three SRS resource sets associated with each of the one or more TRPs.

In some examples of the method, apparatuses, and non-transitory computer-readable medium described herein, each of the one or more TRPs may be associated with a respective quantity of SRS resources, a respective quantity of SRS ports, or a respective quantity of demodulation reference signals, or any combination thereof.

In some examples of the method, apparatuses, and non-transitory computer-readable medium described herein, each of the one or more TRPs may be associated with a respective beam or a respective transmission configuration indicator.

In some examples of the method, apparatuses, and non-transitory computer-readable medium described herein, the outputted second control signaling schedules the multi-TRP communications or the single virtual TRP communication for the uplink communication with the one or more TRPs and the second control signaling includes DCI.

In some examples of the method, apparatuses, and non-transitory computer-readable medium described herein, a SRS resource indicator field or a precoding information and number of layers indicator field, or both, associated with the outputted second control signaling corresponds to a first TRP or a second TRP, or both associated with the set of multiple TRPs based on the outputted second control signaling scheduling the multi-TRP communications.

In some examples of the method, apparatuses, and non-transitory computer-readable medium described herein, a SRS resource indicator field or a precoding information and number of layers indicator field, or both, associated with the outputted second control signaling corresponds to a virtual TRP derived from the set of multiple TRPs based on the outputted second control signaling scheduling the single virtual TRP communication.

In some examples of the method, apparatuses, and non-transitory computer-readable medium described herein, the SRS configuration corresponds to codebook-based wireless communication.

In some examples of the method, apparatuses, and non-transitory computer-readable medium described herein, the SRS configuration corresponds to non-codebook-based wireless communication.

### BRIEF DESCRIPTION OF THE DRAWINGS

FIG. 1 illustrates an example of a wireless communications system that supports managing selection of TRPs in accordance with one or more aspects of the present disclosure.

FIG. 2 illustrates an example of a wireless communications system that supports managing selection of TRPs in accordance with one or more aspects of the present disclosure.

FIGS. 3A through 3C illustrate example of wireless communications systems that support managing selection of TRPs in accordance with one or more aspects of the present disclosure.

FIG. 4 illustrates an example of a wireless communications system that supports managing selection of TRPs in accordance with one or more aspects of the present disclosure.

FIG. 5 illustrates an example of a process flow that supports managing selection of TRPs in accordance with one or more aspects of the present disclosure.

FIGS. 6 and 7 show block diagrams of devices that support managing selection of TRPs in accordance with one or more aspects of the present disclosure.

FIG. 8 shows a block diagram of a communications manager that supports managing selection of TRPs in accordance with one or more aspects of the present disclosure.

FIG. 9 shows a diagram of a system including a device that supports managing selection of TRPs in accordance with one or more aspects of the present disclosure.

FIGS. 10 and 11 show block diagrams of devices that support managing selection of TRPs in accordance with one or more aspects of the present disclosure.

FIG. 12 shows a block diagram of a communications manager that supports managing selection of TRPs in accordance with one or more aspects of the present disclosure.

FIG. 13 shows a diagram of a system including a device that supports managing selection of TRPs in accordance with one or more aspects of the present disclosure.

FIGS. 14 and 15 show flowcharts illustrating methods that support managing selection of TRPs in accordance with one or more aspects of the present disclosure.

### DETAILED DESCRIPTION

A wireless communications system may include a communication device, such as a UE or a network entity (e.g., an eNodeB (eNB), a next-generation NodeB or a giga-NodeB, either of which may be referred to as a gNB, or some other base station), that supports wireless communications over one or multiple radio access technologies. Examples of radio access technologies include 4G systems, such as LTE systems, and 5G systems, which may be referred to as NR systems, or other systems and radio technologies, including future systems and radio technologies not explicitly mentioned herein. The wireless communications may include uplink transmission, uplink reception, downlink transmission, downlink reception, sidelink transmission, or sidelink reception, or a combination thereof. A UE may be configured with multiple antenna panels to support higher reliability and lower latency wireless communications.

The UE may be configured with a single antenna panel to support communication (e.g., uplink communication, downlink communication) with a single TRP. A TRP may be a network entity (or a base station). For example, the UE may support communication with a single TRP using a single antenna panel. This communication may be referred to as single-TRP communication. In some other cases, the UE may be configured with multiple antenna panels, which may be used to support communications with multiple TRPs. This communication may be referred to as multi-TRP communications. The UE may support communications with each TRP using time-division multiplexing (TDM). As part of multi-TRP communications using TDM, the UE may communicate with separate TRPs during separate occasions. Put another way, the UE may not communicate with multiple TRPs simultaneously. As such, the UE may switch communications between TRPs. Each TRP may be associated with a set of TRP parameters, which may correspond to certain TRP restrictions. A TRP restriction may include one or more latency restrictions, power restrictions, bandwidth restrictions, etc. In some cases, the UE may communicate with each TRP or switch communications between TRPs according to these TRP restrictions. In some cases, supporting communication with one or mor TRPs using TDM may be insufficient in throughput. To support higher throughput, the UE may support simultaneous communications with multiple TRPs using other multiplexing techniques.

Various aspects of the present disclosure relate to enabling a UE to manage selection and switching between TRPs (e.g., a base station, a network entity) when supporting simultaneous communications with multiple TRPs. The UE may support communications with multiple TRPs using spatial division multiplexing (SDM) or frequency division multiplexing (FDM). SDM may include multiplexing multiple communications over different spatial channels. FDM may include multiplexing communications over multiple different frequency resources (e.g., subcarriers, carriers). The UE may support communications with multiple TRPs using one or multiple resource sets (e.g., sounding reference signal (SRS) resource sets). A resource set may include one or more resources in a time domain and/or a frequency domain, for example, an SRS resource set may include one or more SRS resources in the time domain and/or the frequency domain. Resource sets may include two or more set of resources (e.g., two or more sets of SRS resources).

The UE may be configured with at least three SRS resource sets for non-codebook-based communications (e.g., in which the UE does not select a beam from a list of predefined beam directions for communication with a TRP) or codebook-based communications (e.g., in which the UE selects a beam from a list of predefined beam directions for communication with a TRP). For example, the UE may receive an SRS configuration indicating at least three SRS resource sets that are all associated with some form of multi-TRP communications. A first SRS resource set, for example, may be associated for communication between the UE and a first TRP during multi-TRP operation. A second SRS resource set may be associated with communication between the UE and a second TRP during multi-TRP operation. A third SRS resource set may be associated with communication between the UE and a virtual TRP that is derived (e.g., determined) from both the first TRP and the second TRP. The third communication may also be referred to as single-TRP communication or a single virtual TRP communication.

In some examples, the UE may receive an indication, for example, via a downlink control information (DCI) that may indicate whether single virtual-TRP communication or multi-TRP communication is scheduled for the UE. Based on this indication and along with other certain TRP restrictions (e.g., latency restrictions, bandwidth restrictions, etc.), the UE may select one or more of the SRS resource sets for the communications and perform the communications with one or more TRPs. The described techniques may thus provide for higher reliability and lower latency wireless communication based on the UE's selection of one or more TRPs. Put another way, by supporting simultaneous communications with multiple TRPs, the UE may experience higher reliability and lower latency wireless communication.

Aspects of the disclosure are initially described in the context of wireless communications systems. Aspects of the disclosure are further illustrated by and described with reference to apparatus diagrams, system diagrams, and flowcharts that relate to managing selection of TRPs.

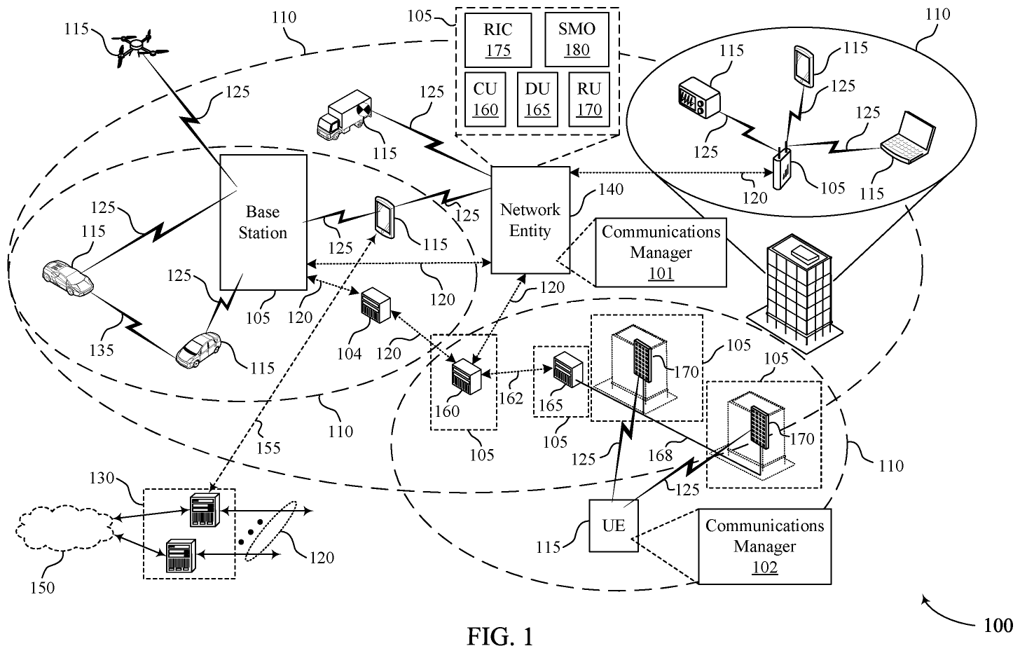

FIG. 1 illustrates an example of a wireless communications system 100 that supports managing selection of TRPs in accordance with one or more aspects of the present disclosure. The wireless communications system 100 may include one or more network entities 105, one or more UEs 115, and a core network 130. In some examples, the wireless communications system 100 may be an LTE network, an LTE-Advanced (LTE-A) network, an LTE-A Pro network, a NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a first one or more components, a first processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104 and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support managing power imbalances and power controls for antennas as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to- (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5GNR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to provide link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may increase throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In the wireless communications system 100, a network entity 105 (or a base station 140) may transmit control signaling to a UE 115 that may indicate one or multiple downlink and uplink transmission configuration indicator (TCI) states. In some cases, the network entity 105 (or the base station 140) may transmit, to the UE 115, control signaling, which may indicate the one or multiple downlink and uplink TCI states to support wireless communication with multiple TRPs (mTRPs) of the network entity 105 (or the base station 140) or different network entities 105 (or base stations 140). The network entity 105 (or the base station 140) may transmit downlink control information (DCI) to the UE 115. Alternatively, the network entity 105 (or the base station 140) may transmit medium access control-control element (MAC-CE) to the UE 115. The DCI or the MAC-CE may include information such as quasi co-location (QCL) relationships between reference signals and reference signal ports associated with the UE 115.

In some examples, the UE 115 may support wireless communication with multiple TRPs of a network entity 105 (or a base station 140) in the wireless communications system 100. In some cases, the UE 115 might not support simultaneous wireless communication with multiple TRPs. In some other cases, the UE 115 may support simultaneous wireless communication with multiple TRPs. For example, the UE 115 may support simultaneous wireless communication with multiple TRPs to support higher throughput and reliability of the wireless communication. The UE 115 may support simultaneous wireless communication with multiple TRPs using multiple antenna panels (e.g., using two antenna panels when communicating with at least two TRPs). In some cases, the UE 115 may support wireless communication with multiple TRPs in the wireless communications system 100 over a particular radio frequency spectrum band (e.g., FR2).

In some examples, the UE 115 may be configured with multiple timing advances to support wireless communication with multiple TRPs of a network entity 105 (or a base station 140) in the wireless communications system 100. For example, the UE 115 may be configured with multiple timing advances via multi-DCI for multi-TRP operation. In some cases, the UE 115 may receive, for example, from the network entity 105 (or the base station 140), a precoder indication (e.g., an uplink precoding indication) for an uplink channel (e.g., a physical uplink shared channel (PUSCH)). A total number of layers may be up to four across all antenna panels of the UE 115 and total number of codewords may be up to two across all antenna panels, considering single DCI and multi-DCI based multi-TRP operation. In some other cases, the UE 115 may receive, for example, from the network entity 105 (or the base station 140), a beam indication (e.g., an uplink beam indication) for an uplink channel (e.g., a physical uplink control channel (PUCCH), a PUSCH)) considering single DCI and multi-DCI based multi-TRP operation. For the case of multi-DCI based multi-TRP operation, PUSCH and PUSCH, or PUCCH and PUCCH may be transmitted by the UE 115 using two antenna panels on a same component carrier.

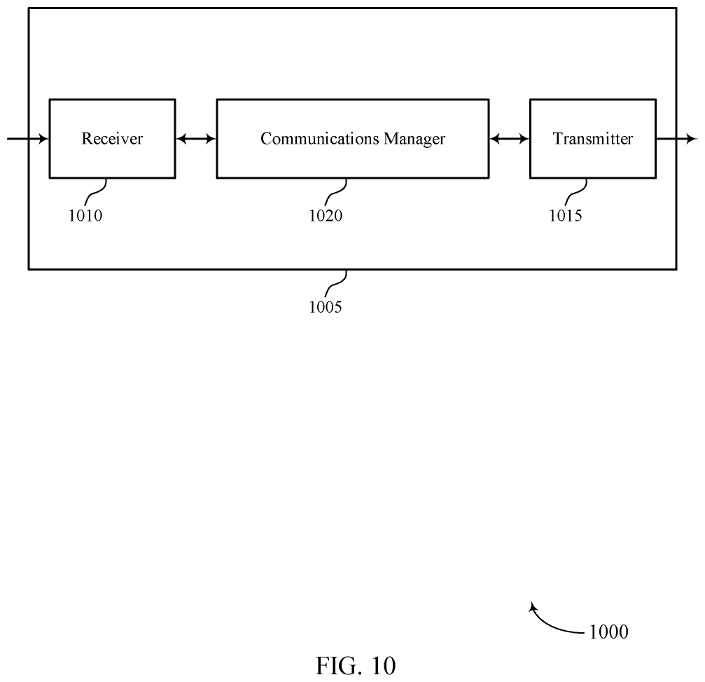

A network entity 105 (or a base station 140) may include a communications manager 101 that may support wireless communication in accordance with examples as disclosed herein. The communications manager 101 may be an example of aspects of a communications manager as described in FIGS. 10 through 13. For example, the communications manager 101 may support managing selection of TRPs in accordance with one or more aspects of the present disclosure. The communications manager 101 may output first control signaling that includes information indicative of an SRS configuration. The SRS configuration indicating a set of at least three SRS resource sets. Each of the set of SRS resource sets being associated with communications between the UE 115 and a respective TRP during one of mTRP communications or sTRP communications. The communications manager 101 may transmit obtain second control signaling that triggers a UE 115 to select one or more SRS resource sets from the set of SRS resource sets for uplink communication.

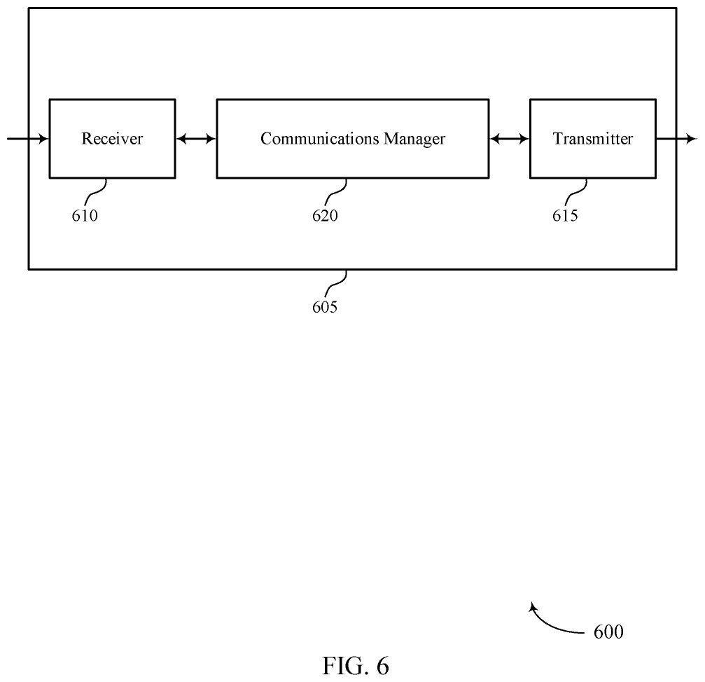

A UE 115 may include a communications manager 102 that may support wireless communication in accordance with examples as disclosed herein. The communications manager 102 may be an example of aspects of a communications manager as described in FIGS. 6 through 9. For example, the communications manager 102 may support managing selection of TRPs in accordance with one or more aspects of the present disclosure. The communication manager 102 may receive first control signaling that includes information indicative of an SRS configuration. The SRS configuration indicating a set of at least three SRS resource sets. Each of the set of SRS resource sets being associated with communications between the UE 115 and a respective TRP during one of mTRP communications or sTRP communications. The communication manager 102 may transmit second control signaling that triggers the UE 115 to select one or more SRS resource sets from the set of SRS resource sets for uplink communication, and perform the uplink communication with one or more TRPs of a set of TRPs using the selected one or more SRS resource sets.

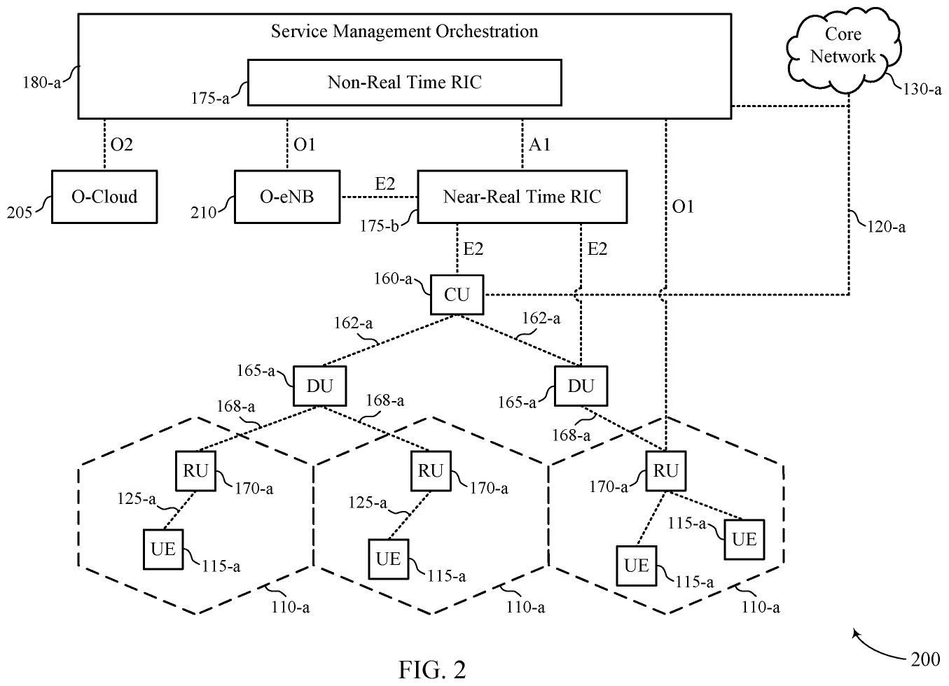

FIG. 2 illustrates an example of a network architecture 200 that (e.g., a disaggregated base station architecture, a disaggregated RAN architecture) that supports managing selection of TRPs in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

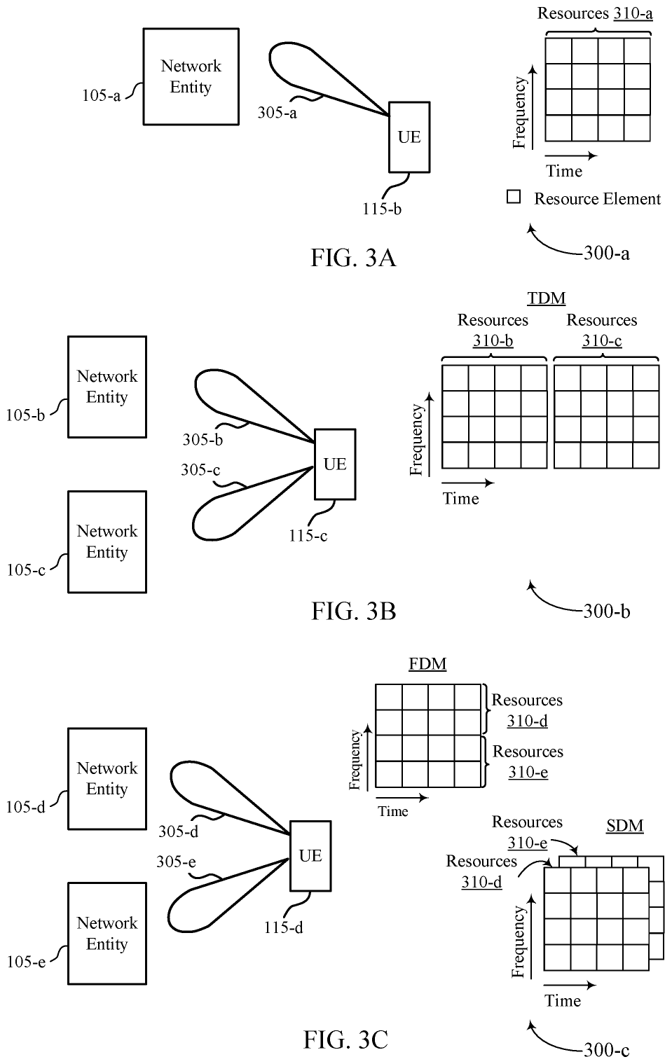

FIG. 3A illustrates an example of a wireless communications system 300-a that supports managing selection of TRPs in accordance with one or more aspects of the present disclosure. The wireless communications system 300-a may implement or be implemented by aspects of the wireless communications system 100 or the network architecture 200 as described in FIGS. 1 and 2, respectively. For example, the wireless communications system 300-a may support multiple radio access technologies including 4G systems such as LTE systems, LTE-A systems, or LTE-A Pro systems, and 5G systems which may be referred to as NR systems, including future systems and radio technologies not explicitly mentioned herein. The wireless communications system 300-a may include a network entity 105-a and a UE 115-b, which may be examples of a network entity 105 and a UE 115 as described with reference to FIG. 1. The network entity 105-a may be an example of a TRP.

The network entity 105-a or the UE 115-b may be equipped with multiple antennas, which may be used to employ techniques such as transmit diversity, receive diversity, MIMO communications, or beamforming. The antennas of the network entity 105-a or the UE 115-b may be located within one or more antenna arrays or antenna panels, which may support MIMO operations or transmit or receive beamforming. The network entity 105-a may have an antenna array with a set of rows and columns of antenna ports that the network entity 105-a may use to support beamforming of communications with the UE 115-b. Likewise, the UE 115-b may have one or more antenna arrays with a set of rows and columns of antenna ports that may support beamforming of communications with the network entity 105-a.

In the example of FIG. 3A, the UE 115-b may perform uplink communication with the network entity 105-a (e.g., a single TRP) over a respective beam 305-a associated with one antenna panel and using one or more resources 310-a. A resource 310-a may include one or more resource elements, which may span one or more time resources (e.g., symbols, mini-slots, slot, etc.) and one or more frequency resources (e.g., subcarriers, carriers, etc.). Accordingly, the wireless communications system 300-a including the UE 115-b may support wireless communication with a single TRP, for example, the network entity 105-a.

FIG. 3B illustrates an example of a wireless communications system 300-b that supports managing selection of TRPs in accordance with one or more aspects of the present disclosure. The wireless communications system 300-b may implement or be implemented by aspects of the wireless communications system 100 or the network architecture 200 as described in FIGS. 1 and 2, respectively. For example, the wireless communications system 300-b may support multiple radio access technologies including 4G systems such as LTE systems, LTE-A systems, or LTE-A Pro systems, and 5G systems which may be referred to as NR systems, including future systems and radio technologies not explicitly mentioned herein. The wireless communications system 300-b may include a network entity 105-b, a network entity 105-c, and a UE 115-c, which may be examples of a network entity 105 and a UE 115 as described with reference to FIG. 1. The network entity 105-b and the network entity 105-c may be examples of TRPs.

The network entity 105-b, the network entity 105-c, or the UE 115-c may be equipped with multiple antennas, which may be used to employ techniques such as transmit diversity, receive diversity, MIMO communications, or beamforming. The antennas of the network entity 105-b, the network entity 105-c, or the UE 115-c may be located within one or more antenna arrays or antenna panels, which may support MIMO operations or transmit or receive beamforming. The network entity 105-b or the network entity 105-c may have an antenna array with a set of rows and columns of antenna ports that the network entity 105-b or the network entity 105-c may use to support beamforming of communications with the UE 115-c. Likewise, the UE 115-c may have one or more antenna arrays with a set of rows and columns of antenna ports that may support beamforming of communications with the network entity 105-b or the network entity 105-c.

In the example of FIG. 3B, the UE 115-c may perform uplink communication with the network entity 105-b (e.g., a TRP) over a respective beam 305-b associated with one antenna panel and using one or more resources 310-b. Additionally or alternatively, the UE 115-c may perform uplink communication with the network entity 105-c (e.g., a TRP) over a respective beam 305-c associated with another antenna panel and using one or more resources 310-c. The resources 310-b and the resources 310-c may include one or more resource elements, which may span one or more time resources (e.g., symbols, mini-slots, slot, etc.) and one or more frequency resources (e.g., subcarriers, carriers, etc.). The UE 115-c may perform uplink communication with the network entity 105-b and the network entity 105-c based on time division multiplexing (TDM) techniques, in which the UE 115-c may perform the uplink communication with the network entity 105-b at a first duration and subsequently perform the uplink communication with the network entity 105-c at a second duration different from the first duration (e.g., after the first duration).

Additionally or alternatively, one or more of the network entity 105-b, the network entity 105-c, or the UE 115-c may support beam management operations. For example, the UE 115-c may support switching uplink communications between the network entity 105-b and the network entity 105-c. In some examples, the network entity 105-b or the network entity 105-c may transmit, to the UE 115-c, an indication, which may trigger the UE 115-c to switch the uplink communications with the network entity 105-b and the network entity 105-c. For example, the network entity 105-b or the network entity 105-c may transmit, to the UE 115-c, a DCI, which may include two or more DCI fields. A DCI field may be configured to contain one or multiple bit values, which may correspond to one of the network entity 105-b or the network entity 105-c, or both.

For example, a DCI field may be configured to contain two bit values that correspond to the network entity 105-b and the network entity 105-c. The UE 115-c may receive the DCI and decode the bit values to determine whether to perform the uplink communications with one or both of the network entity 105-b and the network entity 105-c. Additionally, the bit value may correspond to an order of the uplink communications. The UE 115-c may be associated with the same capabilities for performing the uplink communications with the network entity 105-b and the network entity 105-c (e.g., different TDM'ed TRPs). For example, the UE 115-c may be configured with the same number of SRS resources, the same number of SRS ports, or the same maximum number of layers for the network entity 105-b and the network entity 105-c (e.g., two TRPs).

In some cases, a bit value of ‘00’ may correspond to only a first SRS resource indicator (SRI), which is valid in a DCI, which may be associated with the network entity 105-b. As such, the UE 115-c may perform uplink communications with the network entity 105-b and refrain from performing uplink communications with the network entity 105-c. In some other cases, a bit value of ‘01’ may correspond to only a second SRI, which is valid in a DCI, which may be associated with the network entity 105-c. As such, the UE 115-c may perform uplink communications with the network entity 105-c and refrain from performing uplink communications with the network entity 105-b. In other cases, a bit value of ‘10’ may correspond to both the first SRI and the second SRI that are valid in a DCI. As such, the UE 115-c may perform uplink communications with the network entity 105-b during a first duration and, subsequently, perform uplink communications with the network entity 105-c during a second duration after the first duration. In some other cases, a bit value of ‘11’ may correspond to the second SRI and the first SRI that are valid in a DCI. As such, the UE 115-c may perform uplink communications with the network entity 105-c during a first duration and, subsequently, perform uplink communications with the network entity 105-d during a second duration after the first duration. Accordingly, the wireless communications system 300-b including the UE 115-c may support wireless communication with multiple TRPs (mTRP), for example, with the network entity 105-b and the network entity 105-c using TDM techniques.

FIG. 3C illustrates an example of a wireless communications system 300-c that supports managing selection of TRPs in accordance with one or more aspects of the present disclosure. The wireless communications system 300-c may implement or be implemented by aspects of the wireless communications system 100 or the network architecture 200 as described in FIGS. 1 and 2, respectively. For example, the wireless communications system 300-c may support multiple radio access technologies including 4G systems such as LTE systems, LTE-A systems, or LTE-A Pro systems, and 5G systems which may be referred to as NR systems, including future systems and radio technologies not explicitly mentioned herein. The wireless communications system 300-c may include a network entity 105-d, a network entity 105-e, and a UE 115-d, which may be examples of a network entity 105 and a UE 115 as described with reference to FIG. 1. The network entity 105-d and the network entity 105-e may be examples of TRPs.

The network entity 105-d, the network entity 105-e, or the UE 115-d may be equipped with multiple antennas, which may be used to employ techniques such as transmit diversity, receive diversity, MIMO communications, or beamforming. The antennas of the network entity 105-d, the network entity 105-e, or the UE 115-d may be located within one or more antenna arrays or antenna panels, which may support MIMO operations or transmit or receive beamforming. The network entity 105-d or the network entity 105-e may have an antenna array with a set of rows and columns of antenna ports that the network entity 105-d or the network entity 105-e may use to support beamforming of communications with the UE 115-d. Likewise, the UE 115-d may have one or more antenna arrays with a set of rows and columns of antenna ports that may support beamforming of communications with the network entity 105-d or the network entity 105-e.

In the example of FIG. 3C, the UE 115-d may perform uplink communication with the network entity 105-d (e.g., a TRP) over a respective beam 305-d associated with one antenna panel and using one or more resources 310-d. Additionally or alternatively, the UE 115-d may perform uplink communication with the network entity 105-e (e.g., a TRP) over a respective beam 305-e associated with another antenna panel and using one or more resources 310-e. The resources 310-d and the resources 310-e may include one or more resource elements, which may span one or more time resources (e.g., symbols, mini-slots, slot, etc.) and one or more frequency resources (e.g., subcarriers, carriers, etc.).

The UE 115-d may perform uplink communication with the network entity 105-d and the network entity 105-e based on SDM techniques, in which the UE 115-d may perform the uplink communication with the network entity 105-d and the network entity 105-e over independent channels separated in space. In other words, the UE 115-d may perform the uplink communication with the network entity 105-d and the network entity 105-e by transmitting the uplink communications in separate streams through spatially separated antennas of the UE 115-d. Alternatively, the UE 115-d may perform uplink communication with the network entity 105-d and the network entity 105-e based on FDM, in which the UE 115-d may perform the uplink communication with the network entity 105-d and the network entity 105-e during a same duration (e.g., symbol, mini-slot, slot, etc.) but on different frequency resources (e.g., subcarriers, carriers). Accordingly, the wireless communications system 300-b including the UE 115-d may support wireless communication with mTRP, for example, with the network entity 105-d and the network entity 105-e using SDM or FDM techniques.

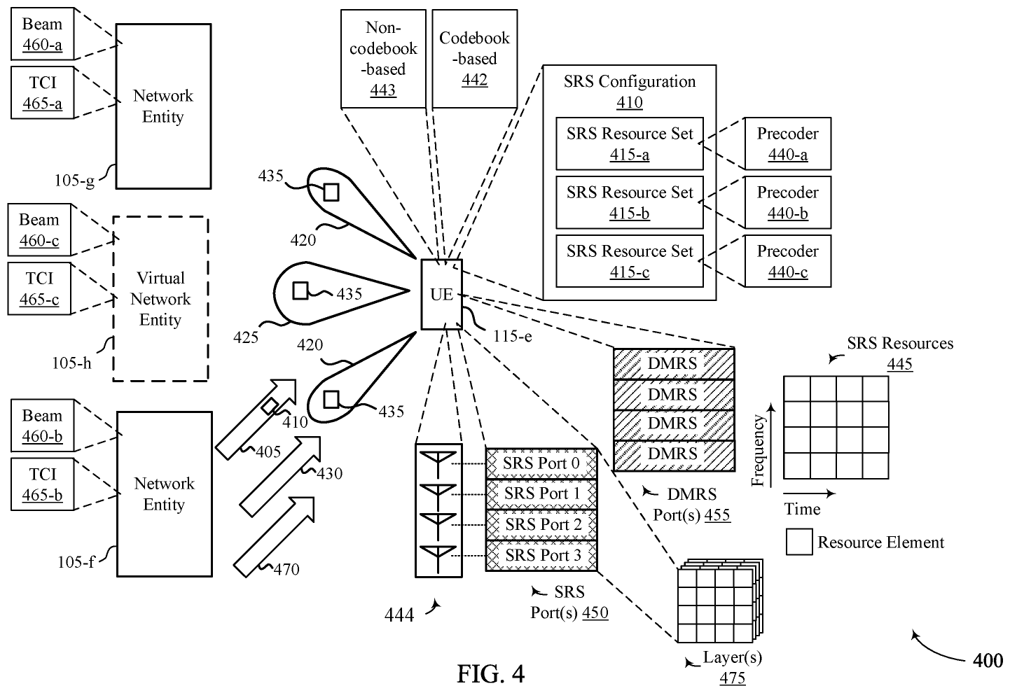

FIG. 4 illustrates an example of a wireless communications system 400 that supports managing selection of TRPs in accordance with one or more aspects of the present disclosure. The wireless communications system 400 may implement or be implemented by aspects of the wireless communications system 100 or the network architecture 200 as described in FIGS. 1 and 2, respectively. For example, the wireless communications system 400 may support multiple radio access technologies including 4G systems such as LTE systems, LTE-A systems, or LTE-A Pro systems, and 5G systems which may be referred to as NR systems, including future systems and radio technologies not explicitly mentioned herein. The wireless communications system 400 may include a network entity 105-f, a network entity 105-g, a virtual network entity 105-h, and a UE 115-e, which may be examples of a network entity 105 and a UE 115 as described with reference to FIG. 1. The network entity 105-f and the network entity 105-g may be example of a TRPs, which may be physical TRPs. The virtual network entity 105-h may be an example of a virtual TRP.

One or more of the network entity 105-f, the network entity 105-g, or the UE 115-e may be equipped with multiple antennas, which may be used to employ techniques such as transmit diversity, receive diversity, MIMO communication, or beamforming. The antennas of one or more of the network entity 105-f, the network entity 105-g, or the UE 115-e may be located within one or more antenna arrays or antenna panels, which may support MIMO operations or transmit or receive beamforming. The network entity 105-f or the network entity 105-g may have an antenna array with a set of rows and columns of antenna ports that the network entity 105-f or the network entity 105-g may use to support beamforming of communication with the UE 115-e. Likewise, the UE 115-e may have one or more antenna arrays with a set of rows and columns of antenna ports that may support beamforming of communications with the network entity 105-f or the network entity 105-g, or both.

In the example of FIG. 4, the UE 115-e may support communications with multiple TRPs (e.g., the network entity 105-f, the network entity 105-g, and/or the network entity 105-h) using SDM. The network entity 105-f may transmit or output, and the UE 115-e may receive or obtain, first control signaling 405 that includes information indicative of an SRS configuration 410. The first control signaling 405, for example, may be an RRC configuration message indicating the SRS configuration 410. The SRS configuration 410 may include or indicate one or multiple SRS resource sets 415. For example, the SRS configuration 410 may indicate at least 3 SRS resource sets 415, including an SRS resource set 415-a, an SRS resource set 415-b, and an SRS resource set 415-c. In some examples, the SRS configuration 410 may correspond to codebook-based uplink communication (e.g. codebook-based 442). In some other examples, the SRS configuration 410 may correspond to non-codebook-based uplink communication (e.g. codebook-based 443). For example, the UE 115-e may be configured with at least 3 SRS resource sets 415 for non-codebook-based uplink MIMO communication or codebook-based uplink MIMO communication. Each SRS resource set of the SRS resource sets 415 may be associated with communication between the UE 115-e and one or more of the network entity 105-f, the network entity 105-g, or the virtual network entity 105-h during one of mTRP communications 420 or single virtual TRP communication 425.

In some examples, the network entity 105-f may transmit or output, and the UE 115-e may receive or obtain, second control signaling 430 that triggers the UE 115-e to select one or more SRS resource sets 415 for uplink communication 435. In some examples, the second control signaling 430 may be dynamic signaling including a TRP selection indicator based on the UE 115-e being configured with the at least 3 SRS resource sets 415. The TRP selection indicator may indicate scheduling of the mTRP communications 420 or the single virtual TRP communication 425. For example, the second control signaling 430 may be a DCI that schedules the mTRP communications 420 or the single virtual TRP communication 425 for the uplink communication 435. In some examples, the UE 115-e may select one or more TRPs associated with one or more of the network entities 105 based on the TRP selection indicator and perform the uplink communication 435 with the one or more selected TRPs.

The UE 115-e may determine a respective precoder 440 for each of the network entities 105 (e.g., a TRP) based on a respective SRS resource set of the at least 3 SRS resource sets 415. Additionally, each SRS resource set of the SRS resource sets 415 may be used to derive precoder information for each network entity 105 (e.g., each TRP) for single virtual TRP operation, multi-TRP operation, or single TRP operation. In some examples, the UE 115-e may determine a precoder 440-a associated with the network entity 105-f (e.g., a TRP), for multi-TRP operation or single TRP operation, based on the SRS resource set 415-a associated with the network entity 105-f. In some examples, the UE 115-e may determine a precoder 440-b associated with the network entity 105-g (e.g., a TRP), for multi-TRP operation or single TRP operation, based on the SRS resource set 415-b associated with the network entity 105-g. In some examples, the UE 115-e may determine a precoder 440-c associated with the virtual network entity 105-h (e.g., a virtual TRP), for single virtual TRP operation, based on the SRS resource set 415-c associated with the virtual network entity 105-h. The UE 115-e may perform the uplink communication 435 with one or more of the network entity 105-f (e.g., a TRP), the network entity 105-g (e.g., a TRP), or the virtual network entity 105-h (e.g., a TRP) based on the determined respective precoders 440 for each of the network entities 105.

In some examples, the UE 115-e may evaluate TRP restrictions associated with a network entity 105. Put another way, the UE 115-e may evaluate TRP restrictions associated with one or more of the network entity 105-f, the network entity 105-g, or the virtual network entity 105-h (e.g., a virtual TRP that is derived from both the network entity 105-f and the network entity 105-g). In some examples of non-codebook-based uplink MIMO communication, the UE 115-e may determine a respective quantity of SRS resources 445 associated with one or more of the network entity 105-f, the network entity 105-g, or the virtual network entity 105-h. In some other examples of codebook-based uplink MIMO communication, the UE 115-e may determine a respective quantity of SRS ports 450 associated with one or more of the network entity 105-f, the network entity 105-g, or the virtual network entity 105-h. In other examples, the UE 115-e may determine a respective quantity of DMRS 455 associated with one or more of the network entity 105-f, the network entity 105-g, or the virtual network entity 105-h. The UE 115-e may select one or more of the SRS resource sets 415 for the uplink communication 435 based on one or more of the determined respective quantity of SRS resources 445, the determined respective quantity of SRS ports 450, or the determined respective quantity of DMRS 455. Each of one or more ports (e.g., SRS ports 450) may be mapped (e.g., associated with) to an antenna of an antenna panel 444 of the UE 115-e.

In some aspects, the TRP restrictions may include MIMO capability, such as a number of SRS resources configured in a SRS resource set, a number of SRS ports in a SRS resource, and a number of layers in uplink MIMO communication. In some examples, such as for codebook-based MIMO, TRP restrictions for the network entity 105-f may be associated with a number of 1 SRS resources, 2 SRS ports, and 2 DMRS ports for an uplink MIMO communication. Similarly, TRP restrictions for the network entity 105-g may be associated with a number of 1 SRS resources, 2 SRS ports, and 2 DMRS ports for uplink MIMO communication. In some examples, such as for codebook-based MIMO, TRP restrictions for a single virtual TRP, for example, the virtual network entity 105-h (e.g., a virtual TRP derived from both the network entity 105-f and the network entity 105-g) may be associated with a number of 2 SRS resources, 4 SRS ports, and 4 DMRS ports.

Each TRP, for example, each network entity 105 may be associated with a beam or a TCI associated with the network entity 105. In some examples, the UE 115-e may determine a beam 460 or a TCI 465, or both, associated with each of the network entity 105-f (e.g., a TRP), the network entity 105-g (e.g., a TRP), or the virtual network entity 105-h (e.g., a virtual TRP derived (e.g., determined) from both the network entity 105-f and the network entity 105-g). For example, the UE 115-e may determine a beam 460-a or a TCI 465-a, or both, associated with the network entity 105-f (e.g., a TRP). In some other examples, the UE 115-e may determine a beam 460-b or a TCI 465-b, or both, associated with the network entity 105-g (e.g., a TRP). In other examples, the UE 115-e may determine a beam 460-c or a TCI 465-c, or both, associated with the virtual network entity 105-h (e.g., a virtual TRP derived from both the network entity 105-f and the network entity 105-g).

For single TRP operation, the uplink communication 435 (e.g., an uplink MIMO transmission) may be associated with at least one TRP (e.g., the virtual network entity 105-h) and at least one SRS resource set. For example, the UE 115-e may determine that the received second control signaling 430 schedules the single virtual TRP communication 425 based on an indication in the received second control signaling 430 (e.g., a DCI). The UE 115-e may select the SRS resource set 415-c based on the second control signaling 430 scheduling the single virtual TRP communication 425. The second control signaling 430 may include an SRI field or a precoding information (e.g., a TPMI indication) and number of layers indicator field associated with the layers 475, or both, that may correspond to the virtual network entity 105-h (e.g., a virtual TRP). The SRI or TPMI indication may be interpreted as one field for sTRP operation, considering across-TRP restrictions for a TRP on a quantity of SRS resources 445, a quantity of SRS ports 450, and a quantity of DMRS 455.

In some aspects, an indication in a DCI field may be configured to contain three bit values that correspond to one or more TRPs. As shown in Table 1, in some cases, a bit value of ‘000’ may correspond to performing communication with a single TRP when in mTRP operation considering per TRP restrictions. For example, the UE 115-e may perform the uplink communication 435 with the network entity 105-f via one or more layers 475 (e.g., one or more spatial layers). As shown in Table 1, in some other cases, a bit value of ‘001’ may correspond to performing communication with a single different TRP in mTRP operation considering per TRP restrictions. For example, the UE 115-e may perform the uplink communication 435 with the network entity 105-g via one or more layers 475 (e.g., one or more spatial layers). As shown in Table 1, in some cases, a bit value of ‘010’ may correspond to performing communications with a multiple TRPs considering per TRP restrictions and an order of performing the communications with the multiple TRPs. For example, the UE 115-e may perform the uplink communication 435 with the network entity 105-f and then perform the uplink communication 435 with the virtual network entity 105-h. As shown in Table 1, alternatively, in some other cases, a bit value of ‘011’ may correspond to performing communications with multiple TRPs considering per TRP restrictions and a different order of performing the communications with the multiple TRPs. For example, the UE 115-e may perform the uplink communication 435 with the virtual network entity 105-h via one or more layers 475 (e.g., one or more spatial layers) and then perform the uplink communication 435 with the network entity 105-g via one or more layers 475 (e.g., one or more spatial layers). As shown in Table 1, in some cases, a bit value of ‘100’ may correspond to performing communication with a single virtual TRP when in sTRP operation considering per TRP restrictions. For example, the UE 115-e may perform the uplink communication 435 with the virtual network entity 105-h. In some aspects, a dedicated indication in a DCI field may be configured to indicate that the uplink communication is with a virtual TRP transmission, or one or more TRPs in mTRP operations.

TABLE 1

| TRP | |
|---|---|
| Switching | |
| Indication | TCI Applied for TRP(s) |
| {000} | 1st TRP only in mTRP operation, considering per-TRP |
| | limit |
| {001} | 2nd TRP only in mTRP operation, considering per-TRP |
| | limit |
| {010} | 1st TRP and 2nd TRP in order, considering per-TRP limit |
| {011} | 2nd TRP and 1st TRP in order, considering per-TRP limit |
| {100} | sTRP operation, considering across-TRP limit |

For mTRP operation, the uplink communication 435 (e.g., an uplink MIMO transmission) may be associated with at least two TRPs (e.g., the network entity 105-f and the network entity 105-g) and at least two SRS resource sets. For example, the UE 115-e may determine that that the received second control signaling 430 schedules the multi-TRP communications 420 based on an indication in the received second control signaling 430 (e.g., a DCI). The UE 115-e may select the SRS resource set 415-a or the SRS resource set 415-b, or both, based on the second control signaling 430 scheduling the multi-TRP communications 420. The second control signaling 430 may include an SRI field or a precoding information (e.g., a TPMI indication) and number of layers indicator field associated with the layers 475, or both, that may correspond to the network entity 105-f (e.g., a TRP) or the network entity 105-g (e.g., a TRP), or both. For example, the SRI and TPMI indication may be interpreted as two fields, for example, of a DCI, for mTRP operation, considering per-TRP restrictions, a quantity of SRS resources 445, a quantity of SRS ports 450, and a quantity of DMRS 455. A first field may correspond to the network entity 105-f and a second field may correspond to the network entity 105-f. If one TRP is not selected for mTRP operation, the corresponding SRI or TPMI field may be ignored.

The network entity 105-f may transmit or output, and the UE 115-e may receive or obtain, third control signaling 470 activating the multi-TRP communications 420 or the single virtual TRP communication 425 for the uplink communication 435. For example, the network entity 105-f may transmit or output, and the UE 115-e may receive or obtain, a medium access control-control element (MAC-CE) activating the multi-TRP communications 420 or the single virtual TRP communication 425 for the uplink communication 435. In some examples, the UE 115-e may perform the uplink communication 435 with one or more of the network entities 105 (e.g., one or more TRPs) based on the received third control signaling 470.

In some examples, the UE 115-e may be configured to select a single SRS resource set 415 and a set of DMRS 455 for the single virtual TRP communication 425 (e.g., single TRP operation) for the uplink communication 435. For example, the UE 115-e may select the SRS resource set 415-a, the SRS resource set 415-b, or the SRS resource set 415-c. In some cases, the UE 115-e might be configured to refrain from enabling multi-TRP operation. For example, the UE 115-e may ignore the received second control signaling 430 that triggers the UE 115-e to select one or more SRS resource sets 415 for uplink communication 435. In some other examples, the UE 115-e may be configured to select multiple SRS resource sets 415 and a set of DMRS 455 for the multi-TRP communications 420 (e.g., multi-TRP operation) for the uplink communication 435. For example, the UE 115-e may select the SRS resource set 415-a and the SRS resource set 415-b. Additionally, the UE 115-e use the dynamic TRP selection indication for TRP selection.

Accordingly, the wireless communications system 400 including the UE 115-e may manage selection of TRPs associated with the network entities 105. By managing selection of TRPs, the UE 115-e may experience higher reliability communications as described herein

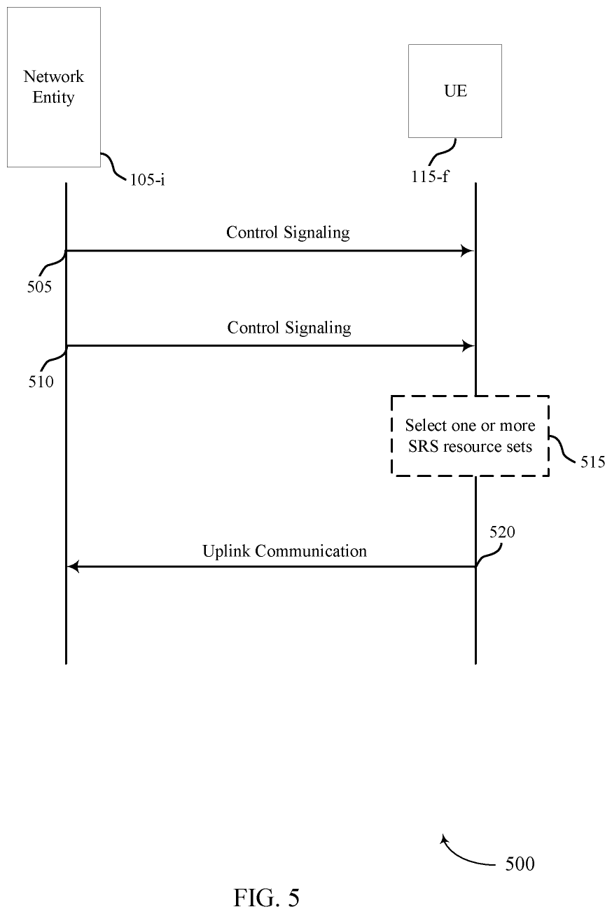

FIG. 5 illustrates an example of a process flow 500 that supports managing selection of TRPs in accordance with one or more aspects of the present disclosure. In some examples, the process flow 500 may implement or be implemented by aspects of the wireless communications system 100 as described with reference to FIG. 1, or the network architecture 200 as described with reference to FIG. 2. For example, the process flow 500 may be implemented by a network entity 105-i and a UE 115-f, which may be an example of a network entity 105 and a UE 115 as described with reference to FIGS. 1 and 2, respectively. In the following description of the process flow 500, the operations between the network entity 105-i and the UE 115-f may be transmitted in a different order than the example order shown, or the operations performed by the network entity 105-i and the UE 115-f may be performed in different orders or at different times. Some operations may also be omitted from the process flow 500, and other operations may be added to the process flow 500.

At 505, the network entity 105-i (e.g., a TRP) may transmit or output, and the UE 115-f may receive control signaling that includes information indicative of a sounding reference signal configuration. The sounding reference signal configuration indicating at least three sounding reference signal resource sets. Each of the at least three sounding reference signal resource sets being associated with communication between the UE 115-f and a respective TRP (e.g., the network entity 105-i and one or more other network entities not shown) during one of multi-TRP communications or single virtual TRP communication based on a set of multiple TRPs. At 510, the network entity 105-i (e.g., a TRP) may transmit or output, and the UE 115-f may receive control signaling that triggers the UE 115-f to select one or more sounding reference signal resource sets from the at least three sounding reference signal resource sets for uplink communication. At 515, the UE 115-f may select one or more SRS resource sets, for example, based on the received control signaling. At 520, the UE 115-f may transmit, and the network entity 105-i may receive or obtain uplink communication.

FIG. 6 shows a block diagram 600 of a device 605 that supports managing selection of TRPs in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to managing selection of TRPs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to managing selection of TRPs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of managing selection of TRPs as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at the device 605 (e.g., a UE) in accordance with examples as disclosed herein. For example, the communications manager 620 may be configured as or otherwise support a means for receiving first control signaling that includes information indicative of a SRS configuration, the SRS configuration indicating at least three SRS resource sets, each of the at least three SRS resource sets being associated with communication between the UE and a respective TRP during one of multi-TRP communications or single virtual TRP communication based on a set of multiple TRPs. The communications manager 620 may be configured as or otherwise support a means for receiving second control signaling that triggers the UE to select one or more SRS resource sets from the at least three SRS resource sets for uplink communication. The communications manager 620 may be configured as or otherwise support a means for communicating the uplink communication with one or more TRPs of the set of multiple TRPs based on the selected one or more SRS resource sets.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced power consumption.

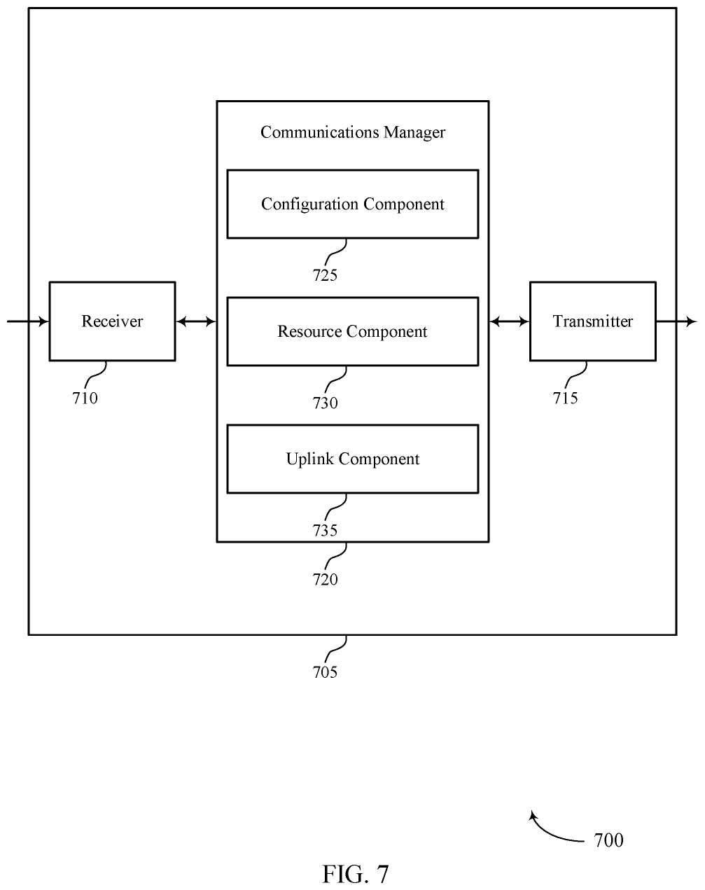

FIG. 7 shows a block diagram 700 of a device 705 that supports managing selection of TRPs in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to managing selection of TRPs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to managing selection of TRPs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of managing selection of TRPs as described herein. For example, the communications manager 720 may include a configuration component 725, a resource component 730, an uplink component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at the device 705 (e.g., a UE) in accordance with examples as disclosed herein. The configuration component 725 may be configured as or otherwise support a means for receiving first control signaling that includes information indicative of a SRS configuration, the SRS configuration indicating at least three SRS resource sets, each of the at least three SRS resource sets being associated with communication between the UE and a respective TRP during one of multi-TRP communications or single virtual TRP communication based on a set of multiple TRPs. The resource component 730 may be configured as or otherwise support a means for receiving second control signaling that triggers the UE to select one or more SRS resource sets from the at least three SRS resource sets for uplink communication. The uplink component 735 may be configured as or otherwise support a means for communicating the uplink communication with one or more TRPs of the set of multiple TRPs based on the selected one or more SRS resource sets.

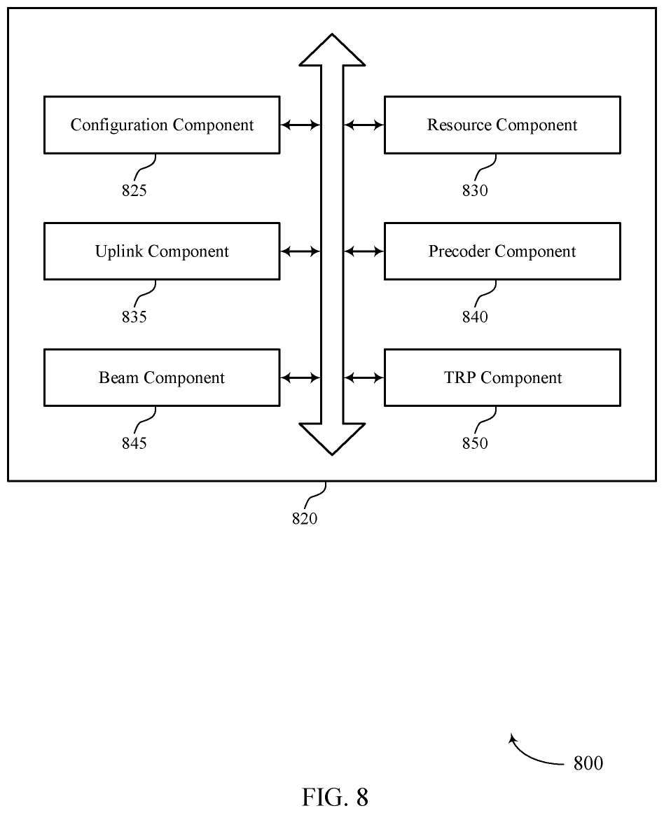

FIG. 8 shows a block diagram 800 of a communications manager 820 that supports managing selection of TRPs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of managing selection of TRPs as described herein. For example, the communications manager 820 may include a configuration component 825, a resource component 830, an uplink component 835, a precoder component 840, a beam component 845, an TRP component 850, or any combination thereof. Each of these components may communicate, directly or indirectly, with one another (e.g., via one or more buses).

The communications manager 820 may support wireless communication at a UE in accordance with examples as disclosed herein. The configuration component 825 may be configured as or otherwise support a means for receiving first control signaling that includes information indicative of a SRS configuration, the SRS configuration indicating at least three SRS resource sets, each of the at least three SRS resource sets being associated with communication between the UE and a respective TRP during one of multi-TRP communications or single virtual TRP communication based on a set of multiple TRPs. The resource component 830 may be configured as or otherwise support a means for receiving second control signaling that triggers the UE to select one or more SRS resource sets from the at least three SRS resource sets for uplink communication. The uplink component 835 may be configured as or otherwise support a means for communicating the uplink communication with one or more TRPs of the set of multiple TRPs based on the selected one or more SRS resource sets.

In some examples, the precoder component 840 may be configured as or otherwise support a means for determining a respective precoder for each of the one or more TRPs based on a respective SRS resource set of the at least three SRS resource sets associated with each of the one or more TRPs. In some examples, the uplink component 835 may be configured as or otherwise support a means for communicating the uplink communication based on the determined respective precoder for each of the one or more TRPs.

In some examples, the resource component 830 may be configured as or otherwise support a means for determining a respective quantity of SRS resources, a respective quantity of SRS ports, a respective quantity of DMRSs, or any combination thereof associated with each of the one or more TRPs based on the received first control signaling. In some examples, the resource component 830 may be configured as or otherwise support a means for selecting the one or more SRS resource sets for the uplink communication based on the determined respective quantity of SRS resources, the determined respective quantity of SRS ports, the determined respective quantity of DMRSs, or any combination thereof associated with each of the one or more TRPs. In some examples, the beam component 845 may be configured as or otherwise support a means for determining a respective beam or a respective TCI associated with each of the one or more TRPs. In some examples, the uplink component 835 may be configured as or otherwise support a means for communicating the uplink communication based on using the determined respective beam or the respective TCI associated with each of the one or more TRPs.

In some examples, the received second control signaling schedules the multi-TRP communications or the single virtual TRP communication for the uplink communication with the one or more TRPs. In some examples, the second control signaling includes DCI. In some examples, the TRP component 850 may be configured as or otherwise support a means for determining that the received second control signaling schedules the multi-TRP communications based on an indication in the received second control signaling. In some examples, the resource component 830 may be configured as or otherwise support a means for selecting a first SRS resource set or a second SRS resource set, or both, based on that the received second control signaling schedules the multi-TRP communications. In some examples, the uplink component 835 may be configured as or otherwise support a means for communicating the uplink communication with a first TRP or a second TRP, or both, using the selected first SRS resource set or the selected second SRS resource set, or both. In some examples, an SRI field or a precoding information and number of layers indicator field, or both, associated with the received second control signaling corresponds to the first TRP or the second TRP, or both associated with the set of multiple TRPs.

In some examples, the TRP component 850 may be configured as or otherwise support a means for determining that the received second control signaling schedules the single virtual TRP communication based on an indication in the received second control signaling. In some examples, the resource component 830 may be configured as or otherwise support a means for selecting a third SRS resource set based on that the received second control signaling schedules the single virtual TRP communication. In some examples, the uplink component 835 may be configured as or otherwise support a means for communicating the uplink communication with a virtual TRP using the selected third SRS resource set, where the virtual TRP is derived from the set of multiple TRPs. In some examples, an SRI field or a precoding information and number of layers indicator field, or both, associated with the received second control signaling corresponds to the third TRP associated with the set of multiple TRPs.

In some examples, the TRP component 850 may be configured as or otherwise support a means for receiving third control signaling activating the multi-TRP communications or the single virtual TRP communication for the uplink communication, the third control signaling including a MAC-CE. In some examples, the uplink component 835 may be configured as or otherwise support a means for communicating the uplink communication with one or more TRPs based on the received third control signaling. In some examples, the resource component 830 may be configured as or otherwise support a means for selecting at least one SRS resource set from the at least three SRS resource sets for the uplink communication based on the received third control signaling activating the single virtual TRP communication for the uplink communication. In some examples, the uplink component 835 may be configured as or otherwise support a means for communicating the uplink communication with a virtual TRP using the selected at least one SRS resource set, where the virtual TRP is derived from the set of multiple TRPs.

In some examples, the resource component 830 may be configured as or otherwise support a means for ignoring the received second control signaling that triggers the UE to select the one or more SRS resource sets from the at least three SRS resource sets for uplink communication based on the received third control signaling. In some examples, the resource component 830 may be configured as or otherwise support a means for selecting at least two SRS resource set from the at least three SRS resource sets for the uplink communication based on the received third control signaling activating the multi-TRP communications for the uplink communication. In some examples, the uplink component 835 may be configured as or otherwise support a means for communicating the uplink communication with a first TRP and a second TRP using the selected at least two SRS resource sets.

In some examples, the SRS configuration corresponds to codebook-based wireless communication. In some examples, the SRS configuration corresponds to non-codebook-based wireless communication.

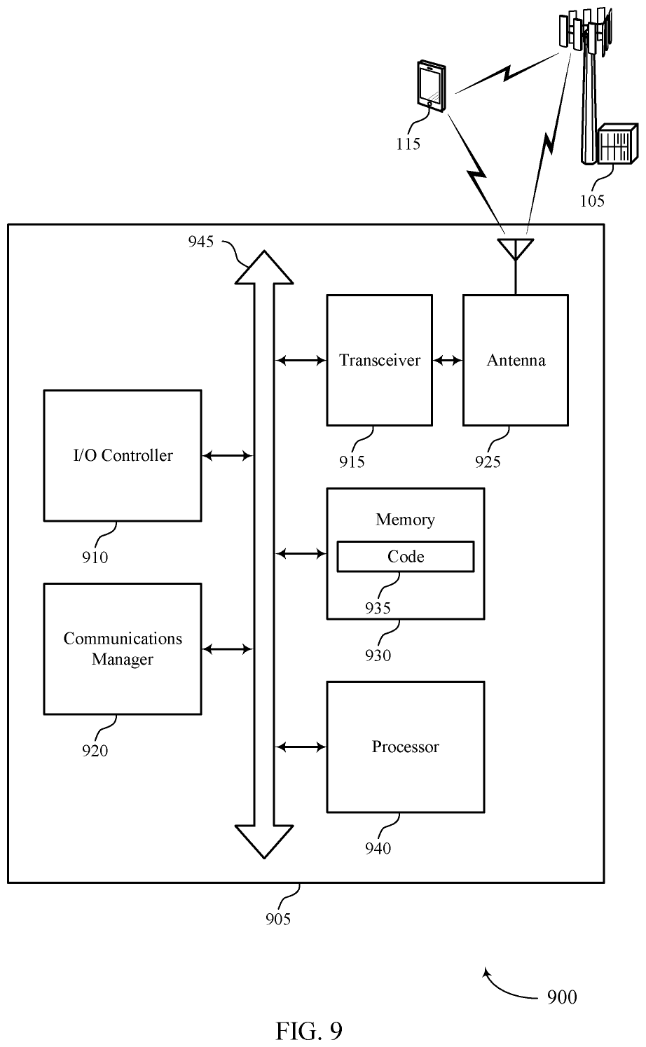

FIG. 9 shows a diagram of a system 900 including a device 905 that supports managing selection of TRPs in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting managing selection of TRPs). For example, the device 905 or a component of the device 905 may include a processor 940 and memory 930 coupled with or to the processor 940, the processor 940 and memory 930 configured to perform various functions described herein.

The communications manager 920 may support wireless communication at the device 905 (e.g., a UE) in accordance with examples as disclosed herein. For example, the communications manager 920 may be configured as or otherwise support a means for receiving first control signaling that includes information indicative of a SRS configuration, the SRS configuration indicating at least three SRS resource sets, each of the at least three SRS resource sets being associated with communication between the UE and a respective TRP during one of multi-TRP communications or single virtual TRP communication based on a set of multiple TRPs. The communications manager 920 may be configured as or otherwise support a means for receiving second control signaling that triggers the UE to select one or more SRS resource sets from the at least three SRS resource sets for uplink communication. The communications manager 920 may be configured as or otherwise support a means for communicating the uplink communication with one or more TRPs of the set of multiple TRPs based on the selected one or more SRS resource sets.

By including or configuring the communications manager 920 in accordance with examples as described herein, the device 905 may support techniques for [[***Add device-level advantages improved communication reliability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of managing selection of TRPs as described herein, or the processor 940 and the memory 930 may be otherwise configured to perform or support such operations.

FIG. 10 shows a block diagram 1000 of a device 1005 that supports managing selection of TRPs in accordance with one or more aspects of the present disclosure. The device 1005 may be an example of aspects of a network entity 105 (e.g., a TRP) as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of managing selection of TRPs as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at the device 1005 (e.g., a network entity) in accordance with examples as disclosed herein. For example, the communications manager 1020 may be configured as or otherwise support a means for outputting first control signaling that includes information indicative of a SRS configuration, the SRS configuration indicating at least three SRS resource sets, each of the at least three SRS resource sets being associated with communication between a UE and a respective TRP during one of multi-TRP communications or single virtual TRP communication based on a set of multiple TRPs. The communications manager 1020 may be configured as or otherwise support a means for outputting second control signaling that triggers the UE to select one or more SRS resource sets from the at least three SRS resource sets for uplink communication with one or more TRPs of the set of multiple TRPs.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced power consumption.

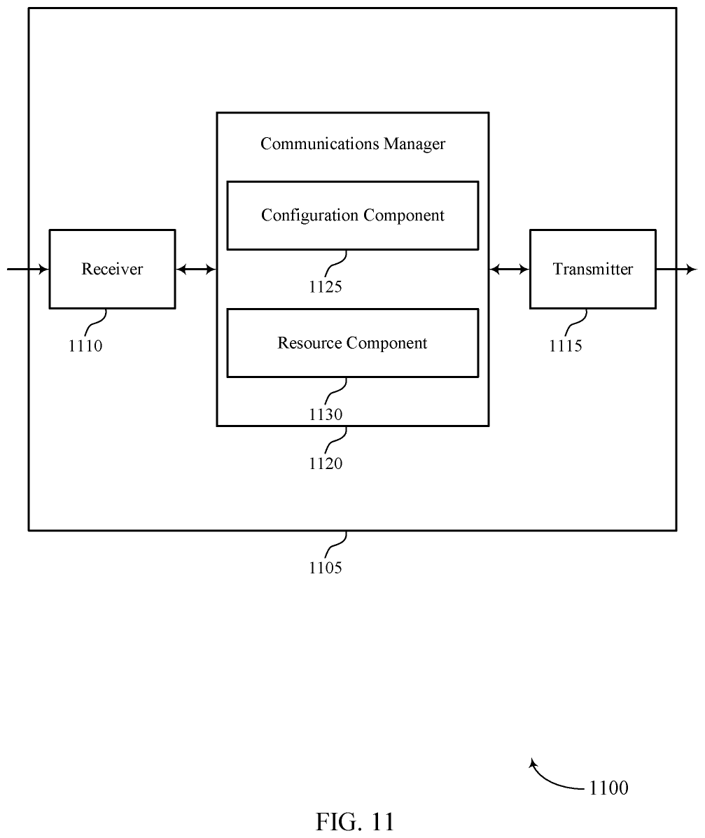

FIG. 11 shows a block diagram 1100 of a device 1105 that supports managing selection of TRPs in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of managing selection of TRPs as described herein. For example, the communications manager 1120 may include a configuration component 1125 a resource component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at the device 1105 (e.g., a network entity) in accordance with examples as disclosed herein. The configuration component 1125 may be configured as or otherwise support a means for outputting first control signaling that includes information indicative of a SRS configuration, the SRS configuration indicating at least three SRS resource sets, each of the at least three SRS resource sets being associated with communication between a UE and a respective TRP during one of multi-TRP communications or single virtual TRP communication based on a set of multiple TRPs. The resource component 1130 may be configured as or otherwise support a means for outputting second control signaling that triggers the UE to select one or more SRS resource sets from the at least three SRS resource sets for uplink communication with one or more TRPs of the set of multiple TRPs.

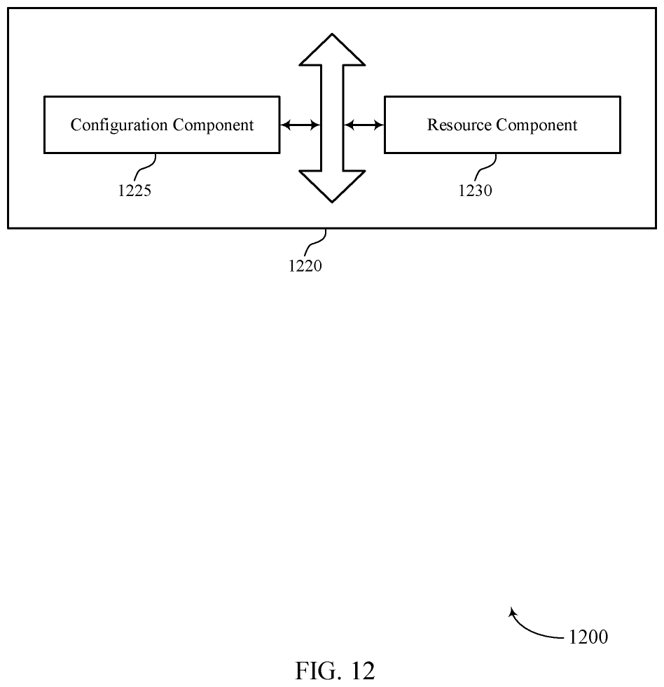

FIG. 12 shows a block diagram 1200 of a communications manager 1220 that supports managing selection of TRPs in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of managing selection of TRPs as described herein. For example, the communications manager 1220 may include a configuration component 1225 a resource component 1230, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The configuration component 1225 may be configured as or otherwise support a means for outputting first control signaling that includes information indicative of a SRS configuration, the SRS configuration indicating at least three SRS resource sets, each of the at least three SRS resource sets being associated with communication between a UE and a respective TRP during one of multi-TRP communications or single virtual TRP communication based on a set of multiple TRPs. The resource component 1230 may be configured as or otherwise support a means for outputting second control signaling that triggers the UE to select one or more SRS resource sets from the at least three SRS resource sets for uplink communication with one or more TRPs of the set of multiple TRPs.

In some examples, a respective precoder for each of the one or more TRPs is based on a respective SRS resource set of the at least three SRS resource sets associated with each of the one or more TRPs. In some examples, each of the one or more TRPs is associated with a respective quantity of SRS resources, a respective quantity of SRS ports, or a respective quantity of DMRSs, or any combination thereof.

In some examples, each of the one or more TRPs is associated with a respective beam or a respective TCI. In some examples, the outputted second control signaling schedules the multi-TRP communications or the single virtual TRP communication for the uplink communication with the one or more TRPs. In some examples, the second control signaling includes DCI.

In some examples, an SRI field or a precoding information and number of layers indicator field, or both, associated with the outputted second control signaling corresponds to a first TRP or a second TRP, or both associated with the set of multiple TRPs based on the outputted second control signaling scheduling the multi-TRP communications. In some examples, an SRI field or a precoding information and number of layers indicator field, or both, associated with the outputted second control signaling corresponds to a virtual TRP derived from the set of multiple TRPs based on the outputted second control signaling scheduling the single virtual TRP communication.

In some examples, the SRS configuration corresponds to codebook-based wireless communication. In some examples, the SRS configuration corresponds to non-codebook-based wireless communication.

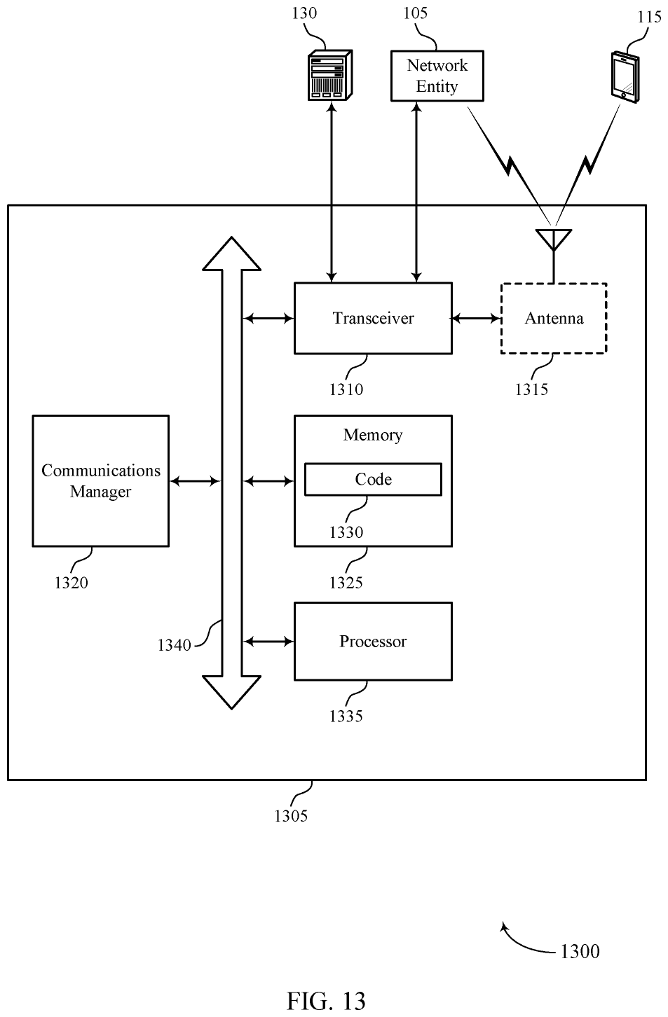

FIG. 13 shows a diagram of a system 1300 including a device 1305 that supports managing selection of TRPs in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting managing selection of TRPs). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at the device 1305 (e.g., a network entity) in accordance with examples as disclosed herein. For example, the communications manager 1320 may be configured as or otherwise support a means for outputting first control signaling that includes information indicative of a SRS configuration, the SRS configuration indicating at least three SRS resource sets, each of the at least three SRS resource sets being associated with communication between a UE and a respective TRP during one of multi-TRP communications or single virtual TRP communication based on a set of multiple TRPs. The communications manager 1320 may be configured as or otherwise support a means for outputting second control signaling that triggers the UE to select one or more SRS resource sets from the at least three SRS resource sets for uplink communication with one or more TRPs of the set of multiple TRPs.

By including or configuring the communications manager 1320 in accordance with examples as described herein, the device 1305 may support techniques for improved communication reliability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of managing selection of TRPs as described herein, or the processor 1335 and the memory 1325 may be otherwise configured to perform or support such operations.

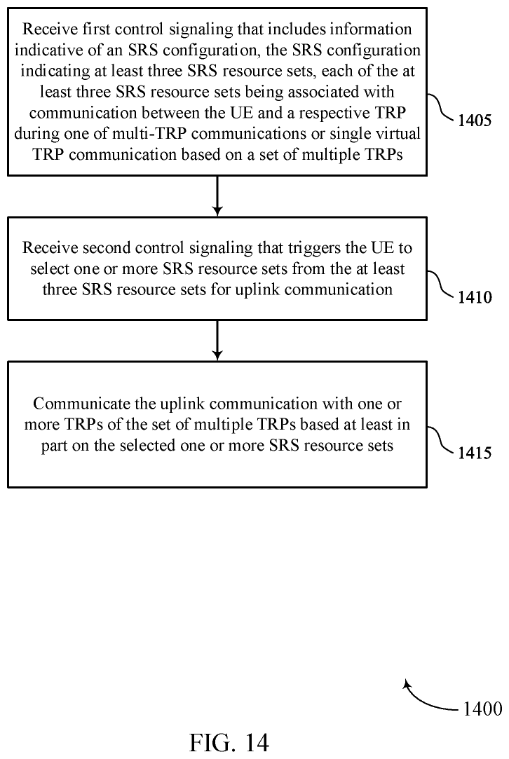

FIG. 14 shows a flowchart illustrating a method 1400 that supports managing selection of TRPs in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving first control signaling that includes information indicative of a SRS configuration, the SRS configuration indicating at least three SRS resource sets, each of the at least three SRS resource sets being associated with communication between the UE and a respective TRP during one of multi-TRP communications or single virtual TRP communication based on a set of multiple TRPs. The operations of 1405 may be performed in accordance with examples as disclosed herein. In some examples, aspects of the operations of 1405 may be performed by a configuration component 825 as described with reference to FIG. 8.

At 1410, the method may include receiving second control signaling that triggers the UE to select one or more SRS resource sets from the at least three SRS resource sets for uplink communication. The operations of 1410 may be performed in accordance with examples as disclosed herein. In some examples, aspects of the operations of 1410 may be performed by a resource component 830 as described with reference to FIG. 8.

At 1415, the method may include communicating the uplink communication with one or more TRPs of the set of multiple TRPs based on the selected one or more SRS resource sets. The operations of 1415 may be performed in accordance with examples as disclosed herein. In some examples, aspects of the operations of 1415 may be performed by an uplink component 835 as described with reference to FIG. 8.

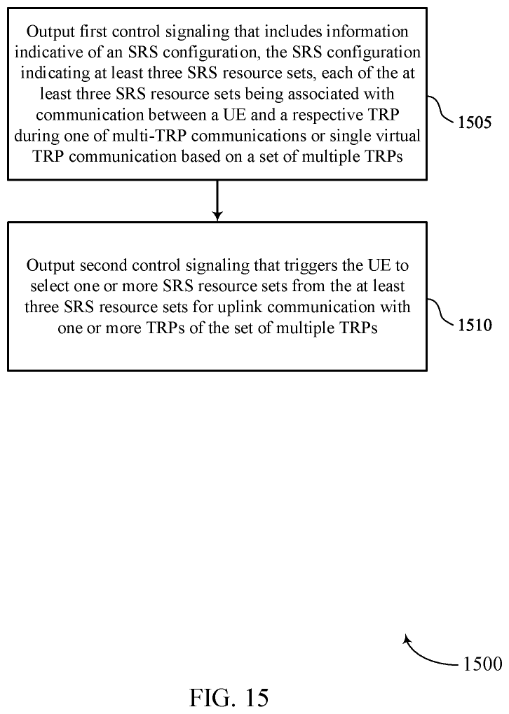

FIG. 15 shows a flowchart illustrating a method 1500 that supports managing selection of TRPs in accordance with one or more aspects of the present disclosure. The operations of the method 1500 may be implemented by a network entity or its components as described herein. For example, the operations of the method 1500 may be performed by a network entity as described with reference to FIGS. 1 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting first control signaling that includes information indicative of a SRS configuration, the SRS configuration indicating at least three SRS resource sets, each of the at least three SRS resource sets being associated with communication between a UE and a respective TRP during one of multi-TRP communications or single virtual TRP communication based on a set of multiple TRPs. The operations of 1505 may be performed in accordance with examples as disclosed herein. In some examples, aspects of the operations of 1505 may be performed by a configuration component 1225 as described with reference to FIG. 12.

At 1510, the method may include outputting second control signaling that triggers the UE to select one or more SRS resource sets from the at least three SRS resource sets for uplink communication with one or more TRPs of the set of multiple TRPs. The operations of 1510 may be performed in accordance with examples as disclosed herein. In some examples, aspects of the operations of 1510 may be performed by a resource component 1230 as described with reference to FIG. 12.

The following provides an overview of aspects of the present disclosure:

Aspect 1: A method for wireless communication at a UE, comprising: receiving first control signaling that includes information indicative of a SRS configuration, the SRS configuration indicating at least three SRS resource sets, each of the at least three SRS resource sets being associated with communication between the UE and a respective TRP during one of multi-TRP communications or single virtual TRP communication based on a set of multiple TRPs; receiving second control signaling that triggers the UE to select one or more SRS resource sets from the at least three SRS resource sets for uplink communication; and communicating the uplink communication with one or more TRPs of the set of multiple TRPs based at least in part on the selected one or more SRS resource sets.

Aspect 2: The method of aspect 1, further comprising: determining a respective precoder for each of the one or more TRPs based at least in part on a respective SRS resource set of the at least three SRS resource sets associated with each of the one or more TRPs, wherein communicating the uplink communication is further based at least in part on the determined respective precoder for each of the one or more TRPs.

Aspect 3: The method of any of aspects 1 through 2, further comprising: determining a respective quantity of SRS resources, a respective quantity of SRS ports, a respective quantity of demodulation reference signals, or any combination thereof associated with each of the one or more TRPs based at least in part on the received first control signaling; and selecting the one or more SRS resource sets for the uplink communication based at least in part on the determined respective quantity of SRS resources, the determined respective quantity of SRS ports, the determined respective quantity of demodulation reference signals, or any combination thereof associated with each of the one or more TRPs.

Aspect 4: The method of any of aspects 1 through 3, further comprising: determining a respective beam or a respective transmission configuration indicator associated with each of the one or more TRPs, wherein communicating the uplink communication is further based at least in part on using the determined respective beam or the respective transmission configuration indicator associated with each of the one or more TRPs.

Aspect 5: The method of any of aspects 1 through 4, wherein the received second control signaling schedules the multi-TRP communications or the single virtual TRP communication for the uplink communication with the one or more TRPs, and the second control signaling comprises DCI.

Aspect 6: The method of aspect 5, further comprising: determining that the received second control signaling schedules the multi-TRP communications based at least in part on an indication in the received second control signaling; and selecting a first SRS resource set or a second SRS resource set, or both, based at least in part on that the received second control signaling schedules the multi-TRP communications, wherein communicating the uplink communication comprises: communicating the uplink communication with a first TRP or a second TRP, or both, using the selected first SRS resource set or the selected second SRS resource set, or both.

Aspect 7: The method of aspect 6, wherein a SRS resource indicator field or a precoding information and number of layers indicator field, or both, associated with the received second control signaling corresponds to the first TRP or the second TRP, or both associated with the set of multiple TRPs.

Aspect 8: The method of any of aspects 5 through 7, further comprising: determining that the received second control signaling schedules the single virtual TRP communication based at least in part on an indication in the received second control signaling; and selecting a third SRS resource set based at least in part on that the received second control signaling schedules the single virtual TRP communication, wherein communicating the uplink communication comprises: communicating the uplink communication with a virtual TRP using the selected third SRS resource set, wherein the virtual TRP is derived from the set of multiple TRPs.

Aspect 9: The method of aspect 8, wherein a SRS resource indicator field or a precoding information and number of layers indicator field, or both, associated with the received second control signaling corresponds to the third TRP associated with the set of multiple TRPs.

Aspect 10: The method of any of aspects 1 through 9, further comprising: receiving third control signaling activating the multi-TRP communications or the single virtual TRP communication for the uplink communication, the third control signaling comprising a medium access control-control element (MAC-CE), wherein communicating the uplink communication with one or more TRPs is further based at least in part on the received third control signaling.

Aspect 11: The method of aspect 10, further comprising: selecting at least one SRS resource set from the at least three SRS resource sets for the uplink communication based at least in part on the received third control signaling activating the single virtual TRP communication for the uplink communication, wherein communicating the uplink communication comprises: communicating the uplink communication with a virtual TRP using the selected at least one SRS resource set, wherein the virtual TRP is derived from the set of multiple TRPs.

Aspect 12: The method of any of aspects 10 through 11, further comprising: ignoring the received second control signaling that triggers the UE to select the one or more SRS resource sets from the at least three SRS resource sets for uplink communication based at least in part on the received third control signaling.

Aspect 13: The method of any of aspects 10 through 12, further comprising: selecting at least two SRS resource set from the at least three SRS resource sets for the uplink communication based at least in part on the received third control signaling activating the multi-TRP communications for the uplink communication, wherein communicating the uplink communication comprises: communicating the uplink communication with a first TRP and a second transmission point using the selected at least two SRS resource sets.

Aspect 14: The method of any of aspects 1 through 13, wherein the SRS configuration corresponds to codebook-based wireless communication.

Aspect 15: The method of any of aspects 1 through 14, wherein the SRS configuration corresponds to non-codebook-based wireless communication.

Aspect 16: A method for wireless communication at a network entity, comprising: outputting first control signaling that includes information indicative of a SRS configuration, the SRS configuration indicating at least three SRS resource sets, each of the at least three SRS resource sets being associated with communication between a UE and a respective TRP during one of multi-TRP communications or single virtual TRP communication based on a set of multiple TRPs; and outputting second control signaling that triggers the UE to select one or more SRS resource sets from the at least three SRS resource sets for uplink communication with one or more TRPs of the set of multiple TRPs.

Aspect 17: The method of aspect 16, wherein a respective precoder for each of the one or more TRPs is based at least in part on a respective SRS resource set of the at least three SRS resource sets associated with each of the one or more TRPs.

Aspect 18: The method of any of aspects 16 through 17, wherein each of the one or more TRPs is associated with a respective quantity of SRS resources, a respective quantity of SRS ports, or a respective quantity of demodulation reference signals, or any combination thereof.

Aspect 19: The method of any of aspects 16 through 18, wherein each of the one or more TRPs is associated with a respective beam or a respective transmission configuration indicator.

Aspect 20: The method of any of aspects 16 through 19, wherein the outputted second control signaling schedules the multi-TRP communications or the single virtual TRP communication for the uplink communication with the one or more TRPs, and the second control signaling comprises DCI.

Aspect 21: The method of aspect 20, wherein a SRS resource indicator field or a precoding information and number of layers indicator field, or both, associated with the outputted second control signaling corresponds to a first TRP or a second TRP, or both associated with the set of multiple TRPs based at least in part on the outputted second control signaling scheduling the multi-TRP communications.

Aspect 22: The method of any of aspects 20 through 21, wherein a SRS resource indicator field or a precoding information and number of layers indicator field, or both, associated with the outputted second control signaling corresponds to a virtual TRP derived from the set of multiple TRPs based at least in part on the outputted second control signaling scheduling the single virtual TRP communication.

Aspect 23: The method of any of aspects 16 through 22, wherein the SRS configuration corresponds to codebook-based wireless communication.

Aspect 24: The method of any of aspects 16 through 23, wherein the SRS configuration corresponds to non-codebook-based wireless communication.

Aspect 25: An apparatus for wireless communication, comprising a processor; and memory coupled with the processor, the processor configured to perform a method of any of aspects 1 through 15.

Aspect 26: An apparatus for wireless communication at a UE, comprising at least one means for performing a method of any of aspects 1 through 15.

Aspect 27: A non-transitory computer-readable medium storing code for wireless communication at a UE, the code comprising instructions executable by a processor to perform a method of any of aspects 1 through 15.

Aspect 28: An apparatus for wireless communication, comprising a processor; and memory coupled with the processor, the processor configured to perform a method of any of aspects 16 through 24.

Aspect 29: An apparatus for wireless communication at a network entity, comprising at least one means for performing a method of any of aspects 16 through 24.

Aspect 30: A non-transitory computer-readable medium storing code for wireless communication at a network entity, the code comprising instructions executable by a processor to perform a method of any of aspects 16 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
a processor; and
memory coupled with the processor, the processor configured to:
receive first control signaling that includes information indicative of a sounding reference signal configuration, the sounding reference signal configuration indicating at least three sounding reference signal resource sets, each of the at least three sounding reference signal resource sets being associated with communication between the apparatus and a respective transmission reception point during one of multi-transmission reception point communications or single virtual transmission reception point communication based on a set of multiple transmission reception points;
receive second control signaling that triggers the apparatus to select one or more sounding reference signal resource sets from the at least three sounding reference signal resource sets for uplink communication; and
communicate the uplink communication with one or more transmission reception points of the set of multiple transmission reception points based at least in part on the selected one or more sounding reference signal resource sets.

2. The apparatus of claim 1, wherein the processor is further configured to:
determine a respective precoder for each of the one or more transmission reception points based at least in part on a respective sounding reference signal resource set of the at least three sounding reference signal resource sets associated with each of the one or more transmission reception points,
wherein to communicate the uplink communication is further based at least in part on the determined respective precoder for each of the one or more transmission reception points.

3. The apparatus of claim 1, wherein the processor is further configured to:
determine a respective quantity of sounding reference signal resources, a respective quantity of sounding reference signal ports, a respective quantity of demodulation reference signals, or any combination thereof associated with each of the one or more transmission reception points based at least in part on the received first control signaling; and
select the one or more sounding reference signal resource sets for the uplink communication based at least in part on the determined respective quantity of sounding reference signal resources, the determined respective quantity of sounding reference signal ports, the determined respective quantity of demodulation reference signals, or any combination thereof associated with each of the one or more transmission reception points.

4. The apparatus of claim 1, wherein the processor is further configured to:
determine a respective beam or a respective transmission configuration indicator associated with each of the one or more transmission reception points,
wherein to communicate the uplink communication is further based at least in part on using the determined respective beam or the respective transmission configuration indicator associated with each of the one or more transmission reception points.

5. The apparatus of claim 1, wherein the received second control signaling schedules the multi-transmission reception point communications or the single virtual transmission reception point communication for the uplink communication with the one or more transmission reception points, and the second control signaling comprises downlink control information (DCI).

6. The apparatus of claim 5, wherein the processor is further configured to:
determine that the received second control signaling schedules the multi-transmission reception point communications based at least in part on an indication in the received second control signaling; and
select a first sounding reference signal resource set or a second sounding reference signal resource set, or both, based at least in part on that the received second control signaling schedules the multi-transmission reception point communications,
wherein, to communicate the uplink communication, the processor is configured to:
communicate the uplink communication with a first transmission reception point or a second transmission reception point, or both, using the selected first sounding reference signal resource set or the selected second sounding reference signal resource set, or both.

7. The apparatus of claim 6, wherein a sounding reference signal resource indicator field or a precoding information and number of layers indicator field, or both, associated with the received second control signaling corresponds to the first transmission reception point or the second transmission reception point, or both associated with the set of multiple transmission reception points.

8. The apparatus of claim 5, wherein the processor is further configured to:
determine that the received second control signaling schedules the single virtual transmission reception point communication based at least in part on an indication in the received second control signaling; and
select a third sounding reference signal resource set based at least in part on that the received second control signaling schedules the single virtual transmission reception point communication,
wherein, to communicate the uplink communication, the processor is configured to:
communicate the uplink communication with a virtual transmission reception point using the selected third sounding reference signal resource set, wherein the virtual transmission reception point is derived from the set of multiple transmission reception points.

9. The apparatus of claim 8, wherein a sounding reference signal resource indicator field or a precoding information and number of layers indicator field, or both, associated with the received second control signaling corresponds to the third transmission reception point associated with the set of multiple transmission reception points.

10. The apparatus of claim 1, further comprising:
an antenna coupled with the processor, wherein the processor is further configured to:
receive third control signaling activating the multi-transmission reception point communications or the single virtual transmission reception point communication for the uplink communication, the third control signaling comprising a medium access control-control element (MAC-CE),
wherein to communicate the uplink communication with one or more transmission reception points is further based at least in part on the received third control signaling.

11. The apparatus of claim 10, wherein the processor is further configured to:
select at least one sounding reference signal resource set from the at least three sounding reference signal resource sets for the uplink communication based at least in part on the received third control signaling activating the single virtual transmission reception point communication for the uplink communication,
wherein, to communicate the uplink communication, the processor is configured to:
communicate the uplink communication with a virtual transmission reception point using the selected at least one sounding reference signal resource set, wherein the virtual transmission reception point is derived from the set of multiple transmission reception points.

12. The apparatus of claim 10, wherein the processor is further configured to:
ignore the received second control signaling that triggers the apparatus to select the one or more sounding reference signal resource sets from the at least three sounding reference signal resource sets for uplink communication based at least in part on the received third control signaling.

13. The apparatus of claim 10, wherein the processor is further configured to:
select at least two sounding reference signal resource set from the at least three sounding reference signal resource sets for the uplink communication based at least in part on the received third control signaling activating the multi-transmission reception point communications for the uplink communication,
wherein, to communicate the uplink communication, the processor is configured to:
communicate the uplink communication with a first transmission reception point and a second transmission reception point using the selected at least two sounding reference signal resource sets.

14. The apparatus of claim 1, wherein the sounding reference signal configuration corresponds to codebook-based wireless communication.

15. The apparatus of claim 1, wherein the sounding reference signal configuration corresponds to non-codebook-based wireless communication.

16. An apparatus for wireless communication:
a processor; and
memory coupled with the processor, the processor configured to:
output first control signaling that includes information indicative of a sounding reference signal configuration, the sounding reference signal configuration indicating at least three sounding reference signal resource sets, each of the at least three sounding reference signal resource sets being associated with communication between a user equipment (UE) and a respective transmission reception point during one of multi-transmission reception point communications or single virtual transmission reception point communication based on a set of multiple transmission reception points; and
output second control signaling that triggers the UE to select one or more sounding reference signal resource sets from the at least three sounding reference signal resource sets for uplink communication with one or more transmission reception points of the set of multiple transmission reception points.

17. The apparatus of claim 16, wherein a respective precoder for each of the one or more transmission reception points is based at least in part on a respective sounding reference signal resource set of the at least three sounding reference signal resource sets associated with each of the one or more transmission reception points.

18. The apparatus of claim 16, wherein each of the one or more transmission reception points is associated with a respective quantity of sounding reference signal resources, a respective quantity of sounding reference signal ports, or a respective quantity of demodulation reference signals, or any combination thereof.

19. The apparatus of claim 16, wherein each of the one or more transmission reception points is associated with a respective beam or a respective transmission configuration indicator.

20. The apparatus of claim 16, further comprising:
an antenna,
wherein the outputted second control signaling schedules the multi-transmission reception point communications or the single virtual transmission reception point communication for the uplink communication with the one or more transmission reception points, and the second control signaling comprises downlink control information (DCI).

21. The apparatus of claim 20, wherein a sounding reference signal resource indicator field or a precoding information and number of layers indicator field, or both, associated with the outputted second control signaling corresponds to a first transmission reception point or a second transmission reception point, or both associated with the set of multiple transmission reception points based at least in part on the outputted second control signaling scheduling the multi-transmission reception point communications.

22. The apparatus of claim 20, wherein a sounding reference signal resource indicator field or a precoding information and number of layers indicator field, or both, associated with the outputted second control signaling corresponds to a virtual transmission reception point derived from the set of multiple transmission reception points based at least in part on the outputted second control signaling scheduling the single virtual transmission reception point communication.

23. The apparatus of claim 16, wherein the sounding reference signal configuration corresponds to codebook-based wireless communication.

24. The apparatus of claim 16, wherein the sounding reference signal configuration corresponds to non-codebook-based wireless communication.

25. A method for wireless communication at a user equipment (UE), comprising:
receiving first control signaling that includes information indicative of a sounding reference signal configuration, the sounding reference signal configuration indicating at least three sounding reference signal resource sets, each of the at least three sounding reference signal resource sets being associated with communication between the UE and a respective transmission reception point during one of multi-transmission reception point communications or single virtual transmission reception point communication based on a set of multiple transmission reception points;
receiving second control signaling that triggers the UE to select one or more sounding reference signal resource sets from the at least three sounding reference signal resource sets for uplink communication; and
communicating the uplink communication with one or more transmission reception points of the set of multiple transmission reception points based at least in part on the selected one or more sounding reference signal resource sets.

26. The method of claim 25, further comprising:
determining a respective precoder for each of the one or more transmission reception points based at least in part on a respective sounding reference signal resource set of the at least three sounding reference signal resource sets associated with each of the one or more transmission reception points,
wherein communicating the uplink communication is further based at least in part on the determined respective precoder for each of the one or more transmission reception points.

27. The method of claim 25, further comprising:
determining a respective quantity of sounding reference signal resources, a respective quantity of sounding reference signal ports, a respective quantity of demodulation reference signals, or any combination thereof associated with each of the one or more transmission reception points based at least in part on the received first control signaling; and
selecting the one or more sounding reference signal resource sets for the uplink communication based at least in part on the determined respective quantity of sounding reference signal resources, the determined respective quantity of sounding reference signal ports, the determined respective quantity of demodulation reference signals, or any combination thereof associated with each of the one or more transmission reception points.

28. A method for wireless communication at a network entity, comprising:
outputting first control signaling that includes information indicative of a sounding reference signal configuration, the sounding reference signal configuration indicating at least three sounding reference signal resource sets, each of the at least three sounding reference signal resource sets being associated with communication between a user equipment (UE) and a respective transmission reception point during one of multi-transmission reception point communications or single virtual transmission reception point communication based on a set of multiple transmission reception points; and
outputting second control signaling that triggers the UE to select one or more sounding reference signal resource sets from the at least three sounding reference signal resource sets for uplink communication with one or more transmission reception points of the set of multiple transmission reception points.

29. The method of claim 28, wherein a respective precoder for each of the one or more transmission reception points is based at least in part on a respective sounding reference signal resource set of the at least three sounding reference signal resource sets associated with each of the one or more transmission reception points.

30. The method of claim 28, wherein each of the one or more transmission reception points is associated with a respective quantity of sounding reference signal resources, a respective quantity of sounding reference signal ports, or a respective quantity of demodulation reference signals, or any combination thereof.
